(19) United States
(12) Patent Application Publication
(10) Pub. No.: US 2026/0329506 A1
(43) Pub. Date: Oct. 22, 2026

(54) INFORMATION PROCESSING DEVICE, INFORMATION PROCESSING SYSTEM, AND INFORMATION PROCESSING METHOD

(71) Applicant: Sony Group Corporation, Tokyo (JP)

(72) Inventors: Haruka MATSUBARA, Tokyo (JP); Tomoaki TAKUMA, Kanagawa (JP); Hironari HOSHINO, Tokyo (JP); Kouichiro TAKASHIMA, Tokyo (JP)

(73) Assignee: Sony Group Corporation, Tokyo (JP)

(21) Appl. No.: 19/112,104

(22) PCT Filed: Aug. 2, 2023
(86) PCT No.: PCT/JP2023/028226

§ 371 Date: Mar. 14, 2025

(30) Foreign Application Priority Data
Sep. 22, 2022 (JP) 2022-151740

(51) Int. Cl. G06F 3/14; G10L 15/22

(52) U.S. Cl. CPC G06F 3/14; G10L 15/22

(57) ABSTRACT

To control display data displayed on a display part of a user terminal that carries out a conversation via a communication network and generate display data visualizing a user state and a conversation state. Received data from the user terminal carrying out a conversation via the communication network is analyzed, and display data having an utterance-text display region including text corresponding to a user utterance to be provided to the user terminal, on the basis of an analysis result is controlled. A display data control unit controls the size, position, color, or a movement of the utterance-text display region or at least one of output images around the utterance-text display region, and generates display data visualizing at least one of a user state and a conversation state of the user carrying out a conversation.

### TECHNICAL FIELD

The present disclosure relates to an information processing device, an information processing system, and an information processing method. More specifically, the present disclosure relates to an information processing device, an information processing system, and an information processing method that generate display data and present the display data to users, the display data visualizing the states of users and the states of conversation, for example, the emotions of participating users and the excitement of conversation, in addition to text output of utterances from users participating conversations in remote meetings or the like via communication networks.

### BACKGROUND ART

Recently, remote meetings such as remote conferences, remote consultation, remote drinking parties, and remote business negotiations have been actively conducted via networks while transmitting and receiving voice and image data using communication terminals.

For example, in a remote conference via a network, user terminals such as PCs and smartphones owned by conference participants are connected via a communication network such as the Internet, and the conference is held while transmitting and receiving images and voice between the terminals.

In addition, systems that convert user utterances into text and display the text on user terminals are also used to allow, for example, hearing-impaired persons to participate in remote meetings.

For example, PTL 1 (JP 2021-071632A) discloses a system that displays utterances as character information in user communications at multiple locations.

However, unlike in face-to-face meetings, the emotions and states of the other party are difficult to grasp in remote meetings using such communication devices.

In particular, in the case of hearing impaired persons, the contents of user utterance can be understood by text displayed on user terminals but the emotions of users are difficult to grasp.

Moreover, it is difficult to understand the overall atmosphere of the meeting, for example, the state of excitement.

### CITATION LIST

### Patent Literature

PTL 1: JP 2021-071632A

### SUMMARY

### Technical Problem

For example, the present disclosure has been devised in view of the problem. An object of the present disclosure is to provide an information processing device, an information processing system, and an information processing method that generate display data and present the display data to users, the display data visualizing the states of users and the states of conversation, for example, the emotions of participating users and the excitement of conversation.

### Solution to Problem

A first aspect of the present disclosure is
an information processing device including:
a data analysis unit that analyzes received data from a user terminal carrying out a conversation via a communication network; and
a display data control unit that controls display data having an utterance-text display region including text corresponding to a user utterance to be provided to the user terminal, on the basis of the analysis result of the data analysis unit, wherein
the display data control unit controls the display mode of at least one of the utterance-text display region and a background region and generates display data visualizing at least one of a user state and a conversation state of a user carrying out a conversation.

Furthermore, a second aspect of the present disclosure is
an information processing system including: a plurality of user terminals that carry out a conversation via a communication network, and a server that manages the conversation, wherein
the user terminal transmits voice data acquired through a microphone and image data captured by a camera to the server,
the server analyzes the voice data and the image data that are received from the user terminal,
as control processing of display data having an utterance-text display region including text corresponding to a user utterance to be provided to the user terminal, the control processing being based on the analysis result,
the server adjusts the display mode of at least one of the utterance-text display region and a background region and generates display data visualizing at least one of a user state and a conversation state of a user carrying out a conversation, and
the user terminal displays the display data including the utterance-text display region on a display part, the display data being generated by the server.

Furthermore, a third aspect of the present disclosure is
an information processing method performed in an information processing device, the method including:
a data analysis step of analyzing received data from a user terminal carrying out a conversation via a communication network by a data analysis unit; and
a display data control step of controlling display data having an utterance-text display region including text corresponding to a user utterance to be provided to the user terminal, on the basis of the analysis result of the data analysis step, by a display data control unit, wherein
the display data control step is a step of controlling the display mode of at least one of the utterance-text display region and a background region and generating display data visualizing at least one of a user state and a conversation state of a user carrying out a conversation.

Still other objects, features and advantages of the present disclosure will become apparent by more detailed description on the basis of the embodiments of the present disclosure and the accompanying drawings described below. In the present specification, the system is a logical set of configurations of a plurality of devices, and the devices having each configuration are not limited to those in the same housing.

According to the configuration of an embodiment of the present disclosure, a configuration is implemented to control display data displayed on the display part of a user terminal that carries out a conversation via a communication network and generate display data visualizing a user state and a conversation state.

Specifically, for example, the configuration analyzes received data from the user terminal carrying out a conversation via the communication network, and controls display data having an utterance-text display region including text corresponding to a user utterance to be provided to the user terminal, on the basis of the analysis result. The display data control unit controls the size, position, color, or a movement of the utterance-text display region or at least one of output images around the utterance-text display region, and generates display data visualizing at least one of a user state and a conversation state of the user carrying out a conversation.

With this configuration, a configuration is implemented to control display data displayed on the display part of the user terminal that carries out a conversation via the communication network and generate display data visualizing a user state and a conversation state.

Note that the effects described in the present specification are merely exemplary and not limited, and may have additional effects.

### BRIEF DESCRIPTION OF DRAWINGS

FIG. 1 is an explanatory drawing showing the overview of the configuration and processing of an information processing system according to the present disclosure.

FIG. 2 is an explanatory drawing showing the overview of display data generated by an information processing device (server).

FIG. 3 is an explanatory drawing showing the overview of display data generated by the information processing device (server).

FIG. 4 is an explanatory drawing illustrating an example of data received by the information processing device (server) from user terminals.

FIG. 5 is an explanatory drawing illustrating a configuration example of the information processing device (server).

FIG. 6 is an explanatory drawing illustrating the detailed configuration of an utterance-text display circle, which is a basic component of the display data generated by the information processing device (server).

FIG. 7 is an explanatory drawing showing a specific example of display data control processing performed by the information processing device (server).

FIG. 8 is an explanatory drawing showing a specific example of display data control processing performed by the information processing device (server).

FIG. 9 is an explanatory drawing showing a specific example of display data control processing performed by the information processing device (server).

FIG. 10 is an explanatory drawing showing a specific example of display data control processing performed by the information processing device (server).

FIG. 11 is an explanatory drawing showing a specific example of display data control processing performed by the information processing device (server).

FIG. 12 is an explanatory drawing showing a specific example of display data control processing performed by the information processing device (server).

FIG. 13 is an explanatory drawing showing a specific example of display data control processing performed by the information processing device (server).

FIG. 14 is an explanatory drawing showing a specific example of display data control processing performed by the information processing device (server).

FIG. 15 is an explanatory drawing showing a specific example of display data control processing performed by the information processing device (server).

FIG. 16 is an explanatory drawing showing a specific example of display data control processing performed by the information processing device (server).

FIG. 17 is an explanatory drawing showing a specific example of display data control processing performed by the information processing device (server).

FIG. 18 is an explanatory drawing showing a specific example of display data control processing performed by the information processing device (server).

FIG. 19 is an explanatory drawing showing a specific example of display data control processing performed by the information processing device (server).

FIG. 20 is an explanatory drawing showing a specific example of display data control processing performed by the information processing device (server).

FIG. 21 is an explanatory drawing showing a specific example of display data control processing performed by the information processing device (server).

FIG. 22 is an explanatory drawing showing a specific example of display data control processing performed by the information processing device (server).

FIG. 23 is an explanatory drawing showing a specific example of display data control processing performed by the information processing device (server).

FIG. 24 is an explanatory drawing showing a specific example of display data control processing performed by the information processing device (server).

FIG. 25 is an explanatory drawing showing a specific example of display data control processing performed by the information processing device (server).

FIG. 26 is an explanatory drawing showing a specific example of display data control processing performed by the information processing device (server).

FIG. 27 is an explanatory drawing showing a specific example of display data control processing performed by the information processing device (server).

FIG. 28 is an explanatory drawing showing a specific example of display data control processing performed by the information processing device (server).

FIG. 29 is an explanatory drawing showing a specific example of display data control processing performed by the information processing device (server).

FIG. 30 is an explanatory drawing showing a specific example of display data control processing performed by the information processing device (server).

FIG. 31 is an explanatory drawing showing a specific example of display data control processing performed by the information processing device (server).

FIG. 32 is an explanatory drawing showing a specific example of display data control processing performed by the information processing device (server).

FIG. 33 is an explanatory drawing showing a specific example of display data control processing performed by the information processing device (server).

FIG. 34 is an explanatory drawing showing a specific example of display data control processing performed by the information processing device (server).

FIG. 35 is an explanatory drawing showing a specific example of display data control processing performed by the information processing device (server).

FIG. 36 is an explanatory drawing showing a specific example of display data control processing performed by the information processing device (server).

FIG. 37 is an explanatory drawing showing a specific example of display data control processing performed by the information processing device (server).

FIG. 38 is an explanatory drawing showing a control processing example of display data using the user terminal operated by a user.

FIG. 39 is an explanatory drawing showing a control processing example of display data using the user terminal operated by the user.

FIG. 40 is an explanatory drawing showing a control processing example of display data using the user terminal operated by the user.

FIG. 41 is an explanatory drawing showing a control processing example of display data using the user terminal operated by the user.

FIG. 42 is an explanatory drawing illustrating an example of data received by the information processing device (server) from the user terminals.

FIG. 43 is an explanatory drawing illustrating a configuration example of the information processing device (server).

FIG. 44 is an explanatory drawing illustrating a configuration example of the user terminal.

FIG. 45 is an explanatory drawing showing a hardware configuration example of the information processing device and the user terminal.

### DESCRIPTION OF EMBODIMENTS

Hereinafter, an information processing device, an information processing system, and an information processing method according to the present disclosure will be described in detail with reference to the accompanying drawings. The description will be given in the following order.
1. Overview of configuration and processing of information processing system according to present disclosure
2. Processing performed by information processing device (server) and configuration example of information processing device (server)
3. Specific example of display data control processing performed by information processing device (server)
4. Display data control processing in user terminal
5. Embodiment of display control performed using user biological information or the like
6. Configuration example of user terminal
7. Hardware configuration example of information processing device and user terminal
8. Summary of configuration of present disclosure

### 1. Overview of Configuration and Processing of Information Processing System According to Present Disclosure

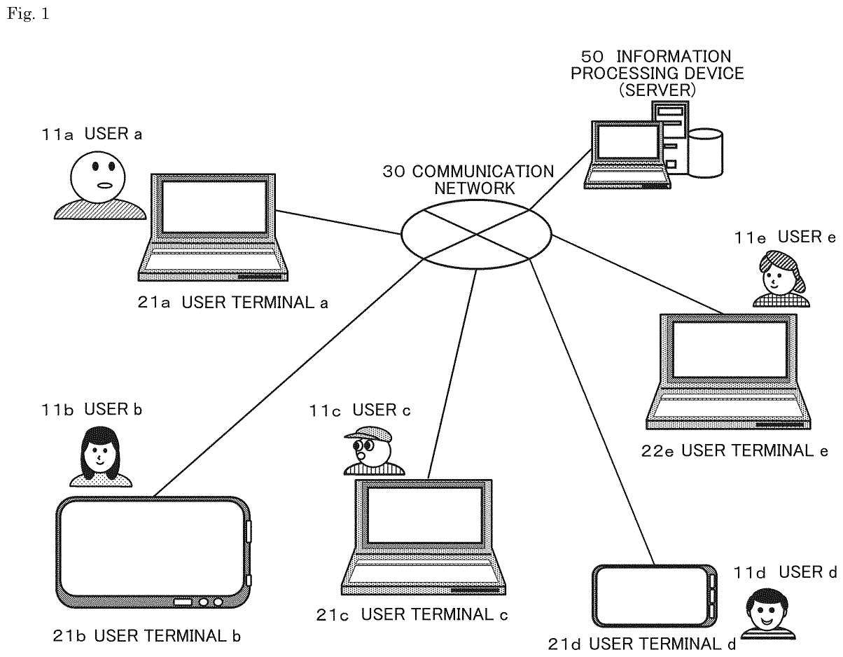

First, referring to FIG. 1 and the subsequent drawings, an overview of the configuration and processing of an information processing system according to the present disclosure will be described below.

FIG. 1 illustrates a configuration example of the information processing system in which remote meetings such as a remote conference or remote consultation are held, that is, conversations are made via a communication network.

FIG. 1 illustrates users a,11a to e,11e serving as participating users carrying out conversations via the communication network, user terminals a,21a to e,21e used by the users, and an information processing device (server) 50 serving as a server for providing a remote meeting environment.

The user terminals a,21a to e,21e and the information processing device (server) 50 are connected via a communication network 30. A remote meeting is held while transmitting and receiving voice and images between communication terminals.

The user terminals 21a to 21e are each composed of a communication-capable information processing device, for example, a PC, a smartphone, or a tablet terminal.

The user terminals 21a to 21e each include a microphone and a camera. Voice data such as user utterances acquired by the microphones of the user terminals 21 and image data such as user face images captured by the cameras are transmitted to the information processing device (server) 50.

The information processing device (server) 50 generates text data corresponding to user utterances by using voice data and image data that are received from the user terminals 21a to 21e, and generates display data that visualizes, for example, the states of the users and the state of the meeting.

The user terminals 21a to 21e receive the utterance voices of the users via the information processing device (server) 50 and output the utterance voices from speakers. Furthermore, display data generated by the information processing device (server) 50 is provided to the user terminals and is displayed on the display parts of the user terminals.

Users 11a to 11e can confirm the utterances of meeting participants as text information and grasp the states of the users and the state of conversation by viewing the display data displayed on the display parts of the user terminals 21a to 21e.

For example, hearing-impaired persons who hardly or cannot hear utterance voices can confirm utterances as text information and grasp the states of the users and the state of conversation by viewing display data generated by the information processing device (server) 50.

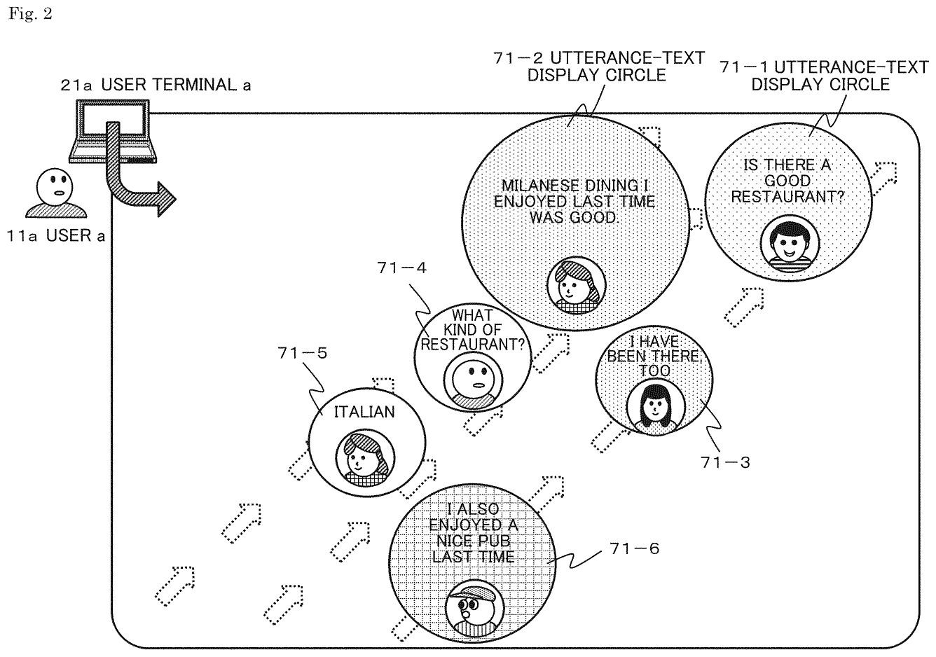

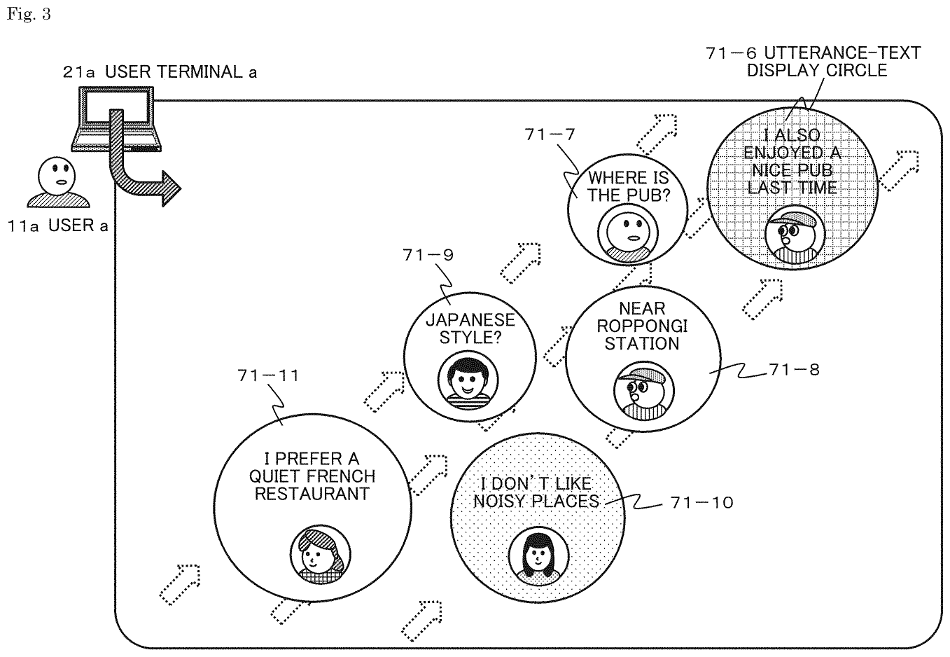

Referring to FIGS. 2 and 3, an overview of display data generated by the information processing device (server) 50 will be described below.

Display data shown in FIG. 2 is an example of display data displayed on the display part of the user terminal a,21a used by the user a,11a, one of users participating in a remote meeting. The same display data is displayed on the user terminals of other users participating in the remote meeting.

The display data is display data generated by the information processing device (server) 50.

As illustrated in FIG. 2, the display data includes time series data of utterance-text display circles 71 that are displayed as utterance text of users participating in the meeting. The utterance-text display circles 71 move from the lower left to the upper right of the display part.

Specifically, the utterance-text display circle corresponding to the latest user utterance is displayed on the lower left of the screen, and the display circle moves to the upper right of the screen with the passage of time. When the utterance-text display circles reach the upper right of the display part, the utterance-text display circles then sequentially disappear from the upper right of the display part.

Dotted-line arrows in the drawing are arrows indicating the flows (moving directions) of the utterance-text display circles 71 and are not displayed on the actual screen.

In the example of the drawing, the utterance-text display circle 71-1 is an utterance-text display circle corresponding to the oldest user utterance in the past, and the subsequent utterance-text display circles corresponding to utterances made with the passage of time are indicated as utterance-text display circles 71-2 to 71-6.

In the example of the drawing, the utterance-text display circle 71-6 is an utterance-text display circle corresponding to the newest user utterance.

In this way, the utterance-text display circles 71-1 to 71-6 in the drawing are utterance-text display circles indicating user utterances arranged from the upper right to the lower left on the time series.

Specifically, in a remote meeting, the following user utterances are sequentially made.
User utterance=Is there a good restaurant?
User utterance=Milanese dining I enjoyed last time was good.
User utterance=I have been there, too.
User utterance=What kind of restaurant?
User utterance=Italian.
User utterance=I also enjoyed a nice pub last time.

As illustrated in FIG. 2, the utterance-text display circles 71-2 to 71-6 are generated and displayed as data including text corresponding to user utterances and the face images of speaking users.

Furthermore, the utterance-text display circles 71-2 to 71-6 are set in different circle sizes and circle colors or the like. The utterance-text display circles 71-2 to 71-6 illustrated in black and white in the drawing are set in various colors in actual display data.

The sizes and colors of the utterance-text display circles 71 are determined by the information processing device (server) 50 on the basis of the volume of the user utterance (voice volume) or the analysis result of utterance contents.

The display data control processing performed by the information processing device (server) 50 will be described in detail later.

FIG. 3 illustrates an example of display data displayed on the display part of the user terminal a,21a used by the user a,11a as in FIG. 2, through the display data is displayed upon the lapse of a certain time after the display data in FIG. 2 is displayed.

The latest utterance-text display circle 71-6 (user utterance=I also enjoyed a nice pub last time.) on the lower left of the screen of the display part in FIG. 2 has moved to the upper right of the screen in the display data in FIG. 3.

The display data in FIG. 3 shows utterance-text display circles 71-7 to 71-11 corresponding to user utterances made after the user utterance of
User utterance=I also enjoyed a nice pub last time.
   in the utterance-text display circle 71-6.

Specifically, in a remote meeting, the following user speech is made:
User utterance=I also enjoyed a nice pub last time.

After this user utterance, the following user utterances are sequentially executed.
User utterance=Where is the pub?
User utterance=Near Roppongi station.
User utterance=Japanese style?
User utterance=I don't like noisy places.
User utterance=I prefer a quiet French restaurant.
The utterance-text display circles 71-6 to 71-11 in FIG. 3 are also data including text corresponding to user utterances and the face images of speaking users. These display circles are also set in different circle sizes and circle colors or the like.

As described above, the sizes and colors of the utterance-text display circles 71 are determined by the information processing device (server) 50 on the basis of the volume of the user utterance (voice volume) or the analysis result of utterance contents. This processing will be specifically described later.

### 2. Processing Performed by Information Processing Device (Server) and Configuration Example of Information Processing Device (Server)

Processing performed by the information processing device (server) 50 and a configuration example of the information processing device (server) will be described below.

As described above, the information processing device (server) 50 receives voice data and image data from the user terminals 21 used by the users in a remote meeting, generates text data corresponding to user utterances, and generates display data that visualizes, for example, the states of the users and the state of the meeting.

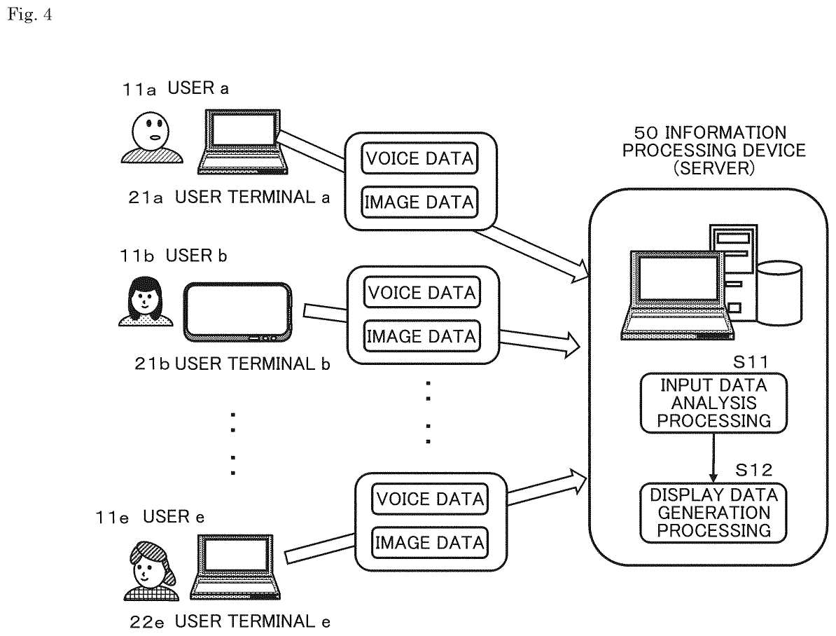

Referring to FIG. 4, an example of data received by the information processing device (server) 50 from the user terminals 21 will be described below.

FIG. 4 illustrates the user terminals 21a to 21e used by multiple users 11a to 11e in a remote meeting, and the information processing device (server) 50.

As illustrated in FIG. 4, the information processing device (server) 50 receives voice data and image data from the user terminals 21a to 21e used by the users 11a to 11e in a remote meeting.

As shown in FIG. 4, the information processing device (server) 50 performs the processing of steps S11 and S12.

Specifically, in step S11, analysis processing is performed on input data (voice data, image data) received from the user terminals 21a to 21e.

In step S12, display data is generated using the data analysis result of step S11. Specifically, display data to be generated includes the time series data of the utterance-text display circles 71 described with reference to FIGS. 2 and 3.

The display data generated by the information processing device (server) 50 includes the time series data of the utterance-text display circles 71 in which the utterance contents of users participating in a remote meeting are displayed in text format. In the display data, the states of speaking users and the state of the meeting (the level of excitement) are visually understandable by, for example, the sizes, colors, and movements of the utterance-text display circles.

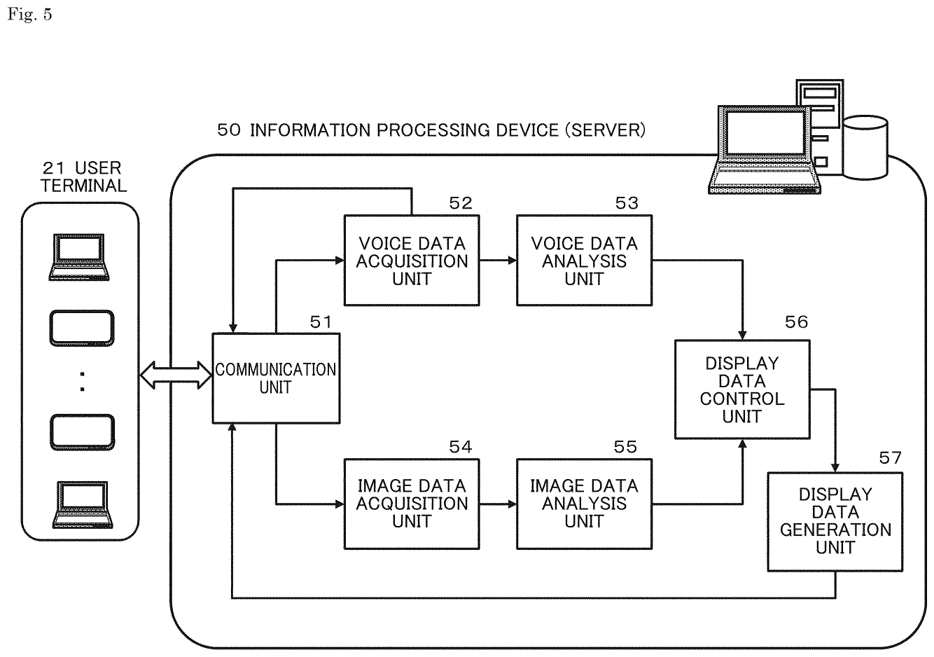

Referring to FIG. 5, a configuration example of the information processing device (server) 50 will be described below.

As shown in FIG. 5, the information processing device (server) 50 includes a communication unit 51, a voice data acquisition unit 52, a voice data analysis unit 53, an image data acquisition unit 54, an image data analysis unit 55, a display data control unit 56, and a display data generation unit 57.

The communication unit 51 receives voice data and image data from the user terminals 21 in a remote meeting.

The voice data to be received is voice data that is acquired by the microphones of the user terminals 21 and includes the utterance voices of the users, laughter, clapping sound, and ambient sound.

Furthermore, the image data is image data that is acquired by the cameras of the user terminals 21 and includes the face images of the users.

In addition, the communication unit 51 transmits voice data including user utterances acquired by the voice data acquisition unit 52 and display data generated by the display data generation unit 57, to the user terminals 21 in a remote meeting.

The user terminals 21 output voices such as user utterances, which are received from the information processing device (server) 50, through the speakers of the user terminals 21 or the headphones attached to the user terminals, and display image data, which is received from the information processing device (server) 50, on the display parts of the user terminals 21.

The voice data acquisition unit 52 selectively acquires voice data from data received by the communication unit 51 and inputs the voice data to the voice data analysis unit 53.

The voice data analysis unit 53 performs analysis processing on the voice data input from the voice data acquisition unit 52.

The voice data to be analyzed is voice data that is acquired by the microphones of the user terminals 21 and includes the utterance voices of the users, laughter, clapping sound, and ambient sound as described above.

The voice analysis result in the voice data analysis unit 53 is input to the display data control unit 56.

The voice data analysis unit 53 performs, for example, volume analysis processing, tone (voice) analysis processing, voice recognition processing, and semantic analysis processing on user utterances in voice data. Furthermore, voice analysis processing is also performed on laughter, groaning, and clapping other than utterances.

The volume analysis processing is processing for calculating a volume of each user utterance, that is, a voice volume. The calculated voice volume of each user utterance is input to the display data control unit 56.

The tone (voice) analysis processing is processing for analyzing the tone (voice) of each user utterance, to be specific, processing for analyzing, for example, whether the user has uttered in a cheerful tone or in a depressed tone. The analysis result is input to the display data control unit 56.

The voice recognition processing is text conversion processing on user utterances. The voice data analysis unit 53 has, for example, an ASR (Automatic Speech Recognition) function and converts voice data into text data including a plurality of words. The generated text data corresponding to user utterances is input to the display data control unit 56.

The semantic analysis processing includes utterance semantic analysis processing and syntactic analysis processing on text data generated by voice recognition processing. The voice data analysis unit 53 has, for example, a natural language understanding function such as NLU (Natural Language Understanding) and performs estimation processing on the intent (Intent) of user utterance and entity information (Entity) from the text data, the entity information referring to meaningful elements included in utterances, and the voice data analysis unit 53 performs extraction of keywords included in user utterances.

Moreover, processing for selecting main utterances or dominant utterances from time-series utterances is also performed.

These analysis results are also input to the display data control unit 56.

The image data acquisition unit 54 selectively acquires image data from data received by the communication unit 51 and inputs the image data to the image data analysis unit 55.

The image data analysis unit 55 performs analysis processing on the image data input from the image data acquisition unit 54.

The image analysis result in the image data analysis unit 55 is input to the display data control unit 56.

Image data to be analyzed by the image data analysis unit 55 is image data that is acquired by the cameras of the user terminals 21 and includes the face images of users participating in a meeting.

The image data analysis unit 55 determines facial expressions by analyzing, for example, the face images of users. The facial expressions of users, for example, expressions of smiling, embarrassment, anger, and sadness are analyzed.

Furthermore, analysis processing or the like is performed on user actions, for example, analysis on whether a user is performing a positive action with a smiling face or a nod or whether a user is performing a negative action with an embarrassed or sad face and headshaking.

Moreover, analysis is also performed on the motions of body parts other than faces, e.g., a waving action.

These image analysis results in the image data analysis unit 55 are input to the display data control unit 56.

The display data control unit 56 receives the voice data analysis result obtained by the voice data analysis unit 53 and the image data analysis result obtained by the image data analysis unit 55 and performs, on the basis of the input data, control processing on image data to be provided to the user terminals 21, that is, the time-series display data of utterance-text display circles including the utterance text of a remote meeting as described with reference to FIGS. 2 and 3.

The display data control unit 56 performs, for example, processing for determining the size of an utterance-text display circle according to the volume of a user's voice, processing for determining the color of an utterance-text display circle according to the tone of a user's voice, and processing for determining the display position and movement of an utterance-text display circle according to the analysis result of a preceding utterance associated with a user utterance.

As described above, the display data control unit 56 performs various types of display data control processing including display data control processing for generating display data that visualizes the emotions and states of users participating in a remote meeting and an atmosphere such as the level of excitement of the overall meeting, that is, processing for determining the sizes, colors, movements, and other effect display modes or the like of utterance-text display circles constituting display data, and processing for determining a background color.

A specific example of the display data control processing will be specifically described in the following sections.

The control information of the display data control unit 56 is input to the display data generation unit 57.

The display data generation unit 57 generates display data according to the sizes, colors, and movements of utterance-text display circles determined by the display data control unit 56 and the mode of a background image.

The display data generated by the display data generation unit 57 is, for example, display data shown in FIGS. 2 and 3. The display data is provided to the user terminals 21 and is displayed on the display parts of the user terminals 21.

### 3. Specific Example of Display Data Control Processing Performed by Information Processing Device (Server)

A specific example of display data control processing performed by the information processing device (server) will be described below.

As described above with reference to FIG. 4, the information processing device (server) 50 receives voice data and image data from the user terminals 21a to 21e used by the users 11a to 11e in a remote meeting, and analyzes the received data (voice data, image data) to generate display data.

In other words, display data to be generated includes the time series data of the utterance-text display circles 71 described with reference to FIGS. 2 and 3.

The display data generated by the information processing device (server) 50 includes the time series data of the utterance-text display circles 71 in which the utterance contents of users participating in a remote meeting are displayed in text format. In the display data, the states of speaking users and the state of the meeting (the level of excitement) are visually understandable by, for example, the sizes, colors, and movements of the utterance-text display circles.

As described above with reference to FIG. 5, the display data control unit 56 of the information processing device (server) 50 receives the voice data analysis result obtained by the voice data analysis unit 53 and the image data analysis result obtained by the image data analysis unit 55 and performs, on the basis of the input data, control processing on image data to be provided to the user terminals 21, that is, the time-series display data of utterance-text display circles including the utterance text of a remote meeting as described with reference to FIGS. 2 and 3.

In other words, the display data control unit 56 performs, for example, processing for determining the size of an utterance-text display circle according to the volume of a user's voice, processing for determining the color of an utterance-text display circle according to the tone of a user's voice, and processing for determining the display position and movement of an utterance-text display circle according to the analysis result of a preceding utterance associated with a user utterance.

As described above, the display data control unit 56 performs various types of display data control processing including display data control processing for generating display data that visualizes the emotions and states of users participating in a remote meeting and an atmosphere such as the level of excitement of the overall meeting, that is, processing for determining the sizes, colors, movements, and other effect display modes or the like of utterance-text display circles constituting display data, and processing for determining a background color.

A specific example of the display data control processing will be described below.

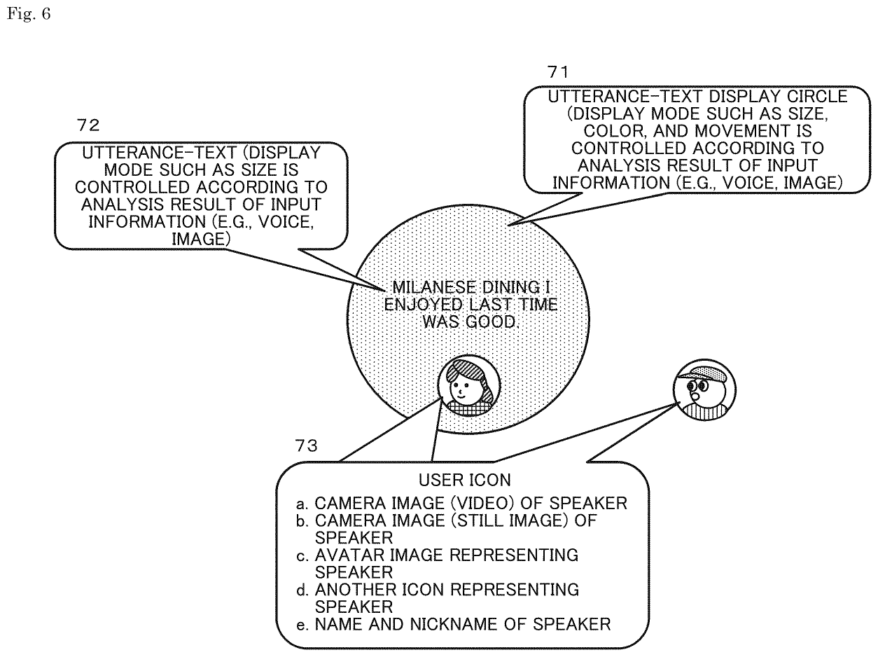

First, referring to FIG. 6, a detailed configuration of the utterance-text display circle 71 serving as a basic component of display data generated by the information processing device (server) 50 will be described below.

FIG. 6 illustrates one utterance-text display circle 71.

The utterance-text display circle 71 includes an utterance text 72 and a user icon 73.

FIG. 6 shows a circular-type utterance-text display circle 71. This shape is just one example, and thus utterance-text display regions may be used in varying shapes, for example, polygons such as squares and hexagons or ovals other than circles.

In the following embodiment, the circular utterance-text display circle 71 is used as an example.

The utterance-text display circle 71 includes the utterance text 72 and the user icon 73.

The utterance text 72 is text data generated by the voice data analysis unit 53 of the information processing device (server) 50 described with reference to FIG. 5, and the text data corresponds to a user utterance input through the microphone of the user terminal 21.

The utterance text 72 displayed in the utterance-text display circle 71 may be subjected to display control processing, for example, enlarged display of a keyword part or text display in a different color from other text parts.

The display control processing is performed in the display data control unit 56 of the information processing device (server) 50 described with reference to FIG. 5.

A specific example of the processing will be described later.

The user icon 73 includes an image or the like that represents the speaking user of the utterance text 72 displayed in the utterance-text display circle 71.

Specifically, for example, one of the following data items is used.
a. Camera image (video) of speaking user
b. Camera image (still image) of speaking user
c. Avatar image representing speaking user
d. Another icon representing speaking user
e. Name and nickname of speaking user

For a user participating in a meeting without utterances on the right side of FIG. 6, processing may be performed to display only the user icon 73 without displaying the utterance-text display circle 71.

For example, when a user does not utter at all in a preset period and the utterance-text display circle 71 of the user is not displayed in the display screen, processing is performed to display only the user icon 73.

Furthermore, as described above with reference to FIG. 5, the display data control unit 56 of the information processing device (server) 50 determines and controls the sizes, colors, movements, and other effect display modes or the like of the utterance-text display circles 71 according to the emotions and states of users participating in a remote meeting and an atmosphere such as the level of excitement of the overall meeting.

In other words, the display data control unit 56 performs display data control processing for generating display data that visualizes, for example, the emotions and states of users participating in a remote meeting and an atmosphere such as the level of excitement of the overall meeting.

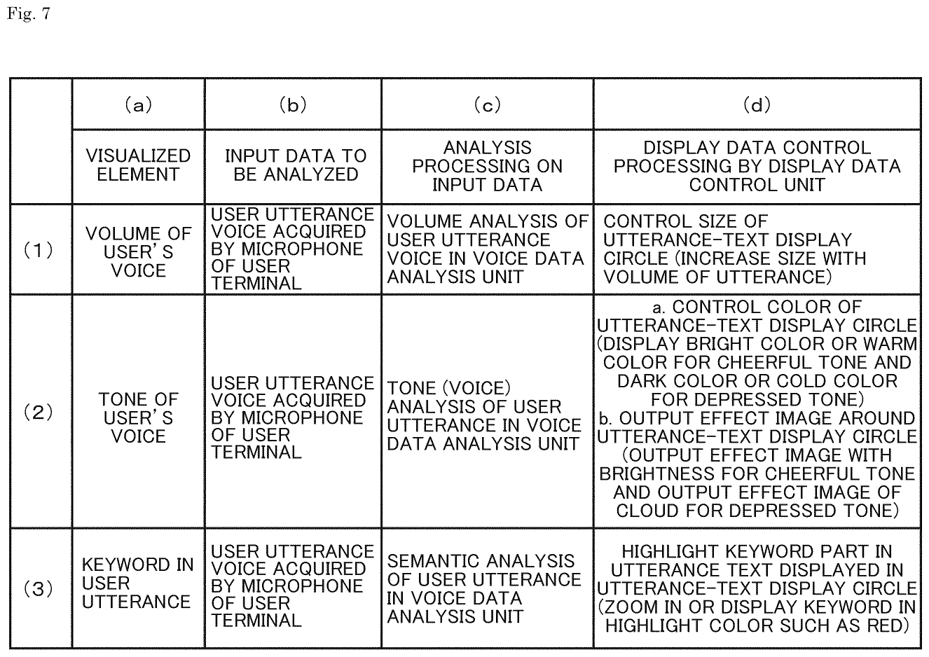

Referring to FIG. 7 and the subsequent drawings, a specific example of the display data control processing performed by the information processing device (server) 50 will be described below.

Tables shown in FIGS. 7 to 14 are tables indicating specific examples of the display data control processing performed by the information processing device (server).

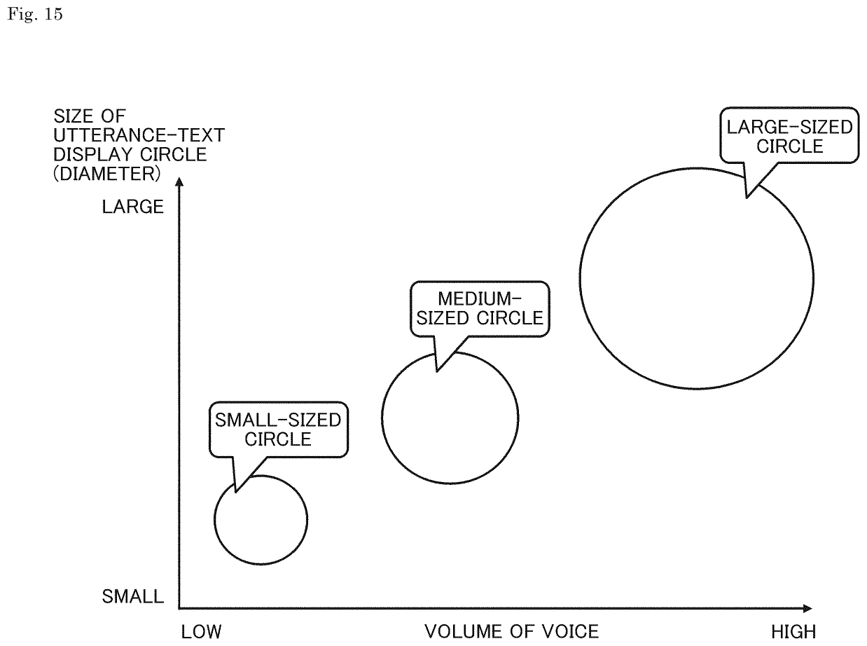

FIG. 15 and the subsequent drawings show specific display examples corresponding to the descriptions the tables in FIGS. 7 to 14.

The tables in FIGS. 7 to 14 show the following items (a) to (d) associated with one another.
(a) Visualized element
(b) Input data to be analyzed
(c) Analysis processing on input data
(d) Display data control processing by display data control unit
(a) Visualized elements are the elements of the state of a speaking user and a conversation state (meeting state), the elements being recognizable by users through viewing of display data generated by the information processing device (server) 50.

Specifically, the voice volume of utterance and the tone of voice are visualized elements.
(b) Input data to be analyzed is data to be analyzed to represent the “(a) Visualized elements” in display data, and the input data is at least one of voice data and image data that are received by the information processing device (server) 50 from the user terminals 21.
(c) Analysis processing on input data describes specific data analysis processing on the “(b) Input data to be analyzed.”
(d) Display data control processing by display data control unit describes a specific example of display data control processing performed by the display data control unit on the basis of the result of “(c) Analysis processing on input data.”

The tables in FIGS. 7 to 14 show lists of 13 types of visualized elements as (a) visualized elements.
(1) Volume of user's voice
(2) Tone of user's voice
(3) Keyword in user utterance
(4) Time-series information of user utterance
(5) User utterance as main utterance or dominant utterance in conversation
(6) Preceding utterance associated with user utterance
(7) User utterance as positive utterance in response to preceding utterance
(8) User utterance as negative utterance in response to preceding utterance
(9) Positive action of user
(10) Negative action of user
(11) Excitement in overall conversation
(12) Decreasing excitement in overall conversation
(13) Classification of opinions

The information processing device (server) 50 controls, for example, display data described above with reference to FIGS. 2 and 3 and generates display data including the visualized elements of (1) to (13).

The display data control processing performed by the information processing device (server) 50 enables users participating in a meeting to recognize various user states and conversation states from display data displayed on the user terminals. For example, the users can recognize the volume and tone of user utterance, a positive or negative user utterance in response to a preceding utterance, whether a user is placed in a positive state or negative state, and the level of excitement of the meeting.

Specific processing examples of visualized elements (1) to (13) shown in FIGS. 7 to 14 will be sequentially described below.
(1) Volume of user's voice

The information processing device (server) 50 performs display data control processing for representing, on display data, “volume of user utterance” of a user participating in a meeting.

Data to be analyzed for display data control processing for representing “volume of user utterance” on display data is a user utterance voice acquired by the microphone of the user terminal 21 as indicated in “(b) of item (1) in the table of FIG. 7.”

Data analysis processing performed for representing “volume of user utterance” on display data is volume analysis of a user utterance voice in the voice data analysis unit 53 as indicated in “(c) of item (1) in the table of FIG. 7.”

Furthermore, display data control processing performed by the display data control unit 56 to represent “volume of user utterance” on display data is processing for controlling the size of a utterance-text display circle as indicated in “(d) of item (1) in the table of FIG. 7.” In other words, processing is performed to increase the size with the volume of utterance.

FIG. 15 shows a specific example of processing performed by the display data control unit 56, that is, a specific example of processing for representing “volume of user utterance” on display data.

The graph shown in FIG. 15 is a graph that sets the volume of voice on the horizontal axis and the size of an utterance-text display circle on the vertical axis.

The volume of voice on the horizontal axis corresponds to the volume of utterance analyzed by the voice data analysis unit 53.

For example, as shown in the graph of FIG. 15, the display data control unit 56 determines the size of an utterance-text display circle output onto display data, according to the volume of utterance analyzed by the voice data analysis unit 53. In other words, processing is performed to increase the size of the utterance-text display circle with the volume of utterance.
(2) Tone of user's voice

The information processing device (server) 50 performs display data control processing for representing, on display data, “tone of user utterance” of a user participating in a meeting.

Data to be analyzed for display data control processing for representing “tone of user utterance” on display data is a user utterance voice acquired by the microphone of the user terminal 21 as indicated in “(b) of item (2) in the table of FIG. 7.”

Data analysis processing performed for representing “tone of user utterance” on display data is tone (voice) analysis of a user utterance voice in the voice data analysis unit 53 as indicated in “(c) of item (2) in the table of FIG. 7.”

Furthermore, display data control processing performed by the display data control unit 56 to represent “tone of user utterance” on display data is at least one of the following processes as indicated in “(d) of item (2) in the table of FIG. 7.”
a. Control the color of an utterance-text display circle (display a bright color or a warm color for a cheerful tone and a dark color or a cold color for a depressed tone)
b. Output an effect image around an utterance-text display circle (output an effect image with brightness for a cheerful tone and output an effect image of cloud for a depressed tone)

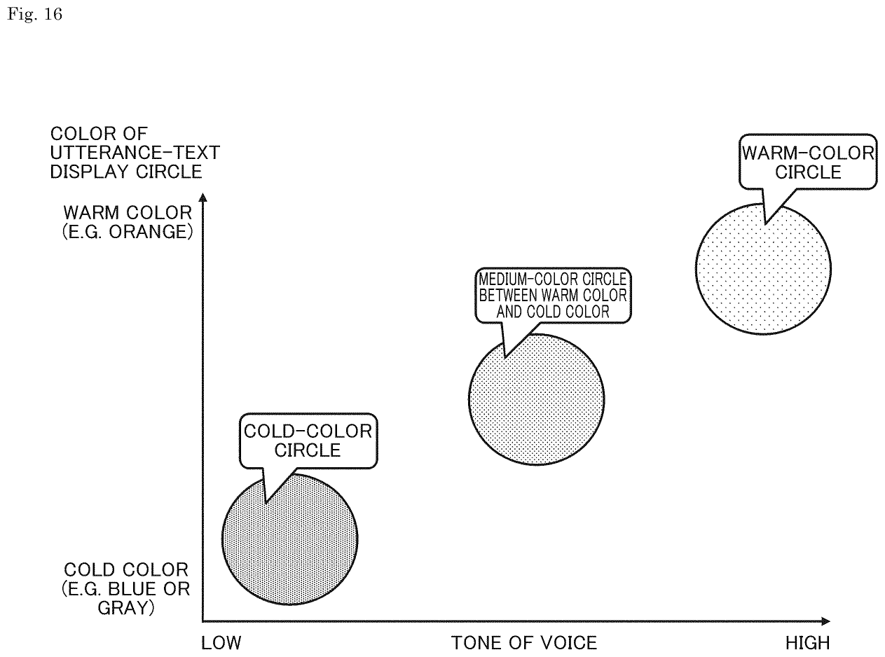

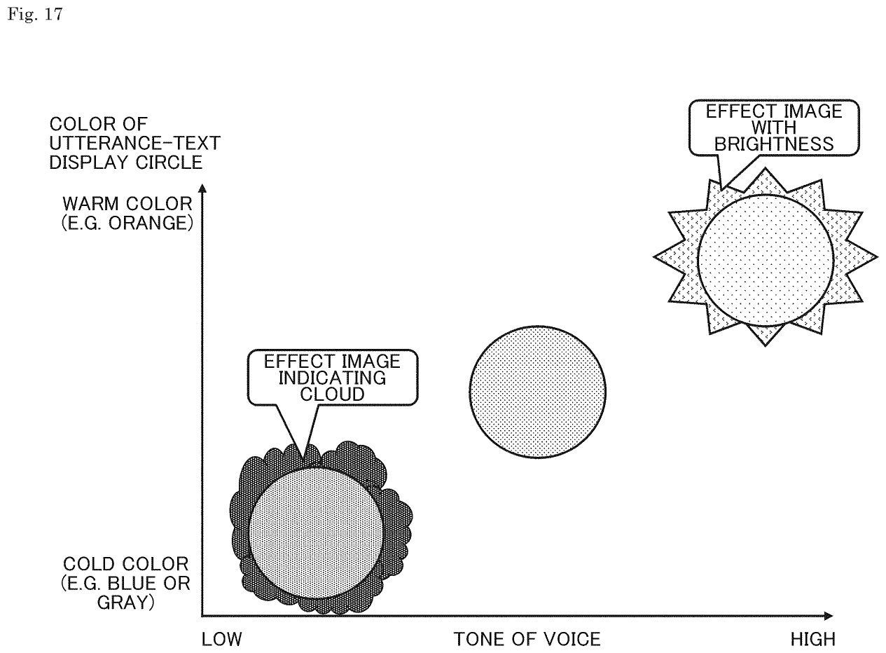

FIGS. 16 and 17 show specific examples of processing performed by the display data control unit 56, that is, specific examples of processing for representing “tone of user utterance” on display data.

FIG. 16 shows a processing example of the processing of a, and FIG. 17 shows a processing example in which the processing of a and the processing of b are performed in combination.

A graph in FIG. 16, which shows the processing example of the processing of a, is a graph that sets the tone of voice on the horizontal axis and the color of an utterance-text display circle on the vertical axis.

The tone of voice on the horizontal axis corresponds to the tone of utterance analyzed by the voice data analysis unit 53.

The color of an utterance-text display circle on the vertical axis is a cold color (e.g., blue or gray) on the lower side and a warm color (e.g., orange) on the upper side.

For example, as shown in the graph of FIG. 16, the display data control unit 56 determines the color of an utterance-text display circle output onto display data, according to the tone of user utterance analyzed by the voice data analysis unit 53.

In other words, processing is performed such that the color of an utterance-text display circle is set to a warm color such as orange as the tone of utterance becomes cheerful, and the color of an utterance-text display circle is set to a cold color such as blue or gray as the tone of utterance becomes depressed.

As in FIG. 16, in a graph of FIG. 17 showing the processing example in which the processing of a and the processing of b are performed in combination, the graph sets the tone of voice on the horizontal axis and the color of an utterance-text display circle on the vertical axis.

The tone of voice on the horizontal axis corresponds to the tone of utterance analyzed by the voice data analysis unit 53.

The color of an utterance-text display circle on the vertical axis is a cold color (e.g., blue or gray) on the lower side and a warm color (e.g., orange) on the upper side.

For example, as shown in the graph of FIG. 17, the display data control unit 56 determines the color of an utterance-text display circle output onto display data, according to the tone of user utterance analyzed by the voice data analysis unit 53.

Processing is performed such that the color of an utterance-text display circle is set to a warm color such as orange as the tone of utterance becomes cheerful, and the color of an utterance-text display circle is set to a cold color such as blue or gray as the tone of utterance becomes depressed.

Furthermore, in the example of FIG. 17, an effect image corresponding to the tone of utterance is output around the utterance-text display circle. Specifically, an effect image with brightness is output for a cheerful tone, whereas an effect image of cloud is output for a depressed tone.
(3) Keyword in user utterance

The information processing device (server) 50 performs display data control processing for representing, on display data, “keyword in user utterance” of a user participating in a meeting.

Data to be analyzed for display data control processing for representing “keyword in user utterance” on display data is a user utterance voice acquired by the microphone of the user terminal 21 as indicated in “(b) of item (3) in the table of FIG. 7.”

Data analysis processing performed for representing “keyword in user utterance” on display data is semantic analysis of a user utterance voice in the voice data analysis unit 53 as indicated in “(c) of item (3) in the table of FIG. 7.”

Furthermore, display data control processing performed by the display data control unit 56 to represent “keyword in user utterance” on display data is processing for highlighting a keyword part in utterance text displayed in an utterance-text display circle, as indicated in “(d) of item (3) in the table of FIG. 7.” For example, processing is performed to zoom in on a keyword part or display a keyword part in a highlight color such as red.

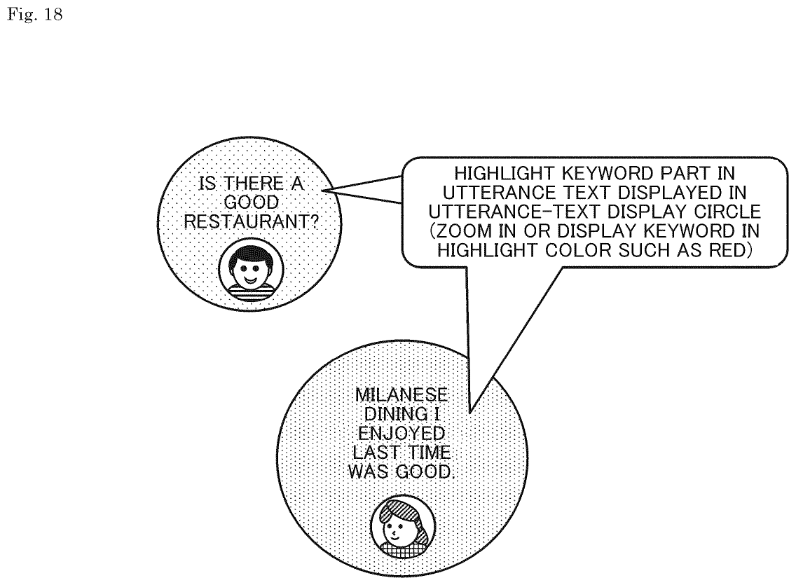

FIG. 18 show a specific example of processing performed by the display data control unit 56, that is, a specific example of processing for representing “keyword in user utterance” on display data.

FIG. 18 illustrates two utterance-text display circles.

Utterance text displayed in each of the utterance-text display circles includes a keyword extracted by semantic analysis of a user utterance voice in the voice data analysis unit 53.

The utterance text of the utterance-text display circle on the upper left is:
“Is there a good restaurant?”

The voice data analysis unit 53 performs semantic analysis of the user utterance and extracts the following word as a keyword.
“Restaurant”

In this case, display data control processing performed by the display data control unit 56 is processing for zooming in on the characters of the keyword “restaurant” or displaying the keyword in a highlight color such as red.

Moreover, the utterance text of the utterance-text display circle on the lower right is:
“Milanese dining I enjoyed last time was good.”

The voice data analysis unit 53 performs semantic analysis of the user utterance and extracts the following word as a keyword.
“Milanese dining”

In this case, display data control processing performed by the display data control unit 56 is processing for zooming in on the characters of the keyword “Milanese dining” or displaying the keyword in a highlight color such as red.
(4) Time-series information of user utterance

The information processing device (server) 50 performs display data control processing for representing, on display data, “time-series information of user utterance” of a user participating in a meeting.

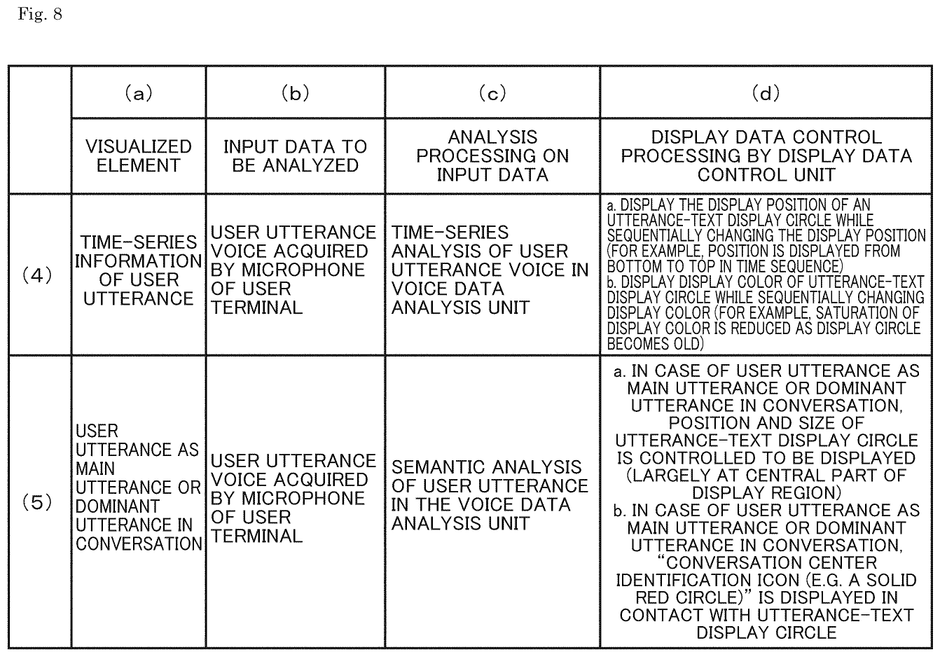

Data to be analyzed for display data control processing for representing “time-series information of user utterance” on display data is a user utterance voice acquired by the microphone of the user terminal 21 as indicated in “(b) of item (4) in the table of FIG. 8.”

Data analysis processing performed for representing “time-series information of user utterance” on display data is time-series analysis of a user utterance voice in the voice data analysis unit 53 as indicated in “(c) of item (4) in the table of FIG. 8.”

Furthermore, display data control processing performed by the display data control unit 56 to represent “time-series information of user utterance” on display data is at least one of the following processes a and b as indicated in “(d) of item (4) in the table of FIG. 8.”
a. Display the display position of an utterance-text display circle while sequentially changing the display position. For example, the position is displayed from the bottom to the top in time sequence.
b. Display the display color of an utterance-text display circle while sequentially changing the display color. For example, the saturation of the display color is reduced as the display circle becomes old.

The processes of a and b may be performed separately or in combination.

The display data control unit 56 performs at least one of the processes a and b to represent “time-series information of user utterance” on display data.

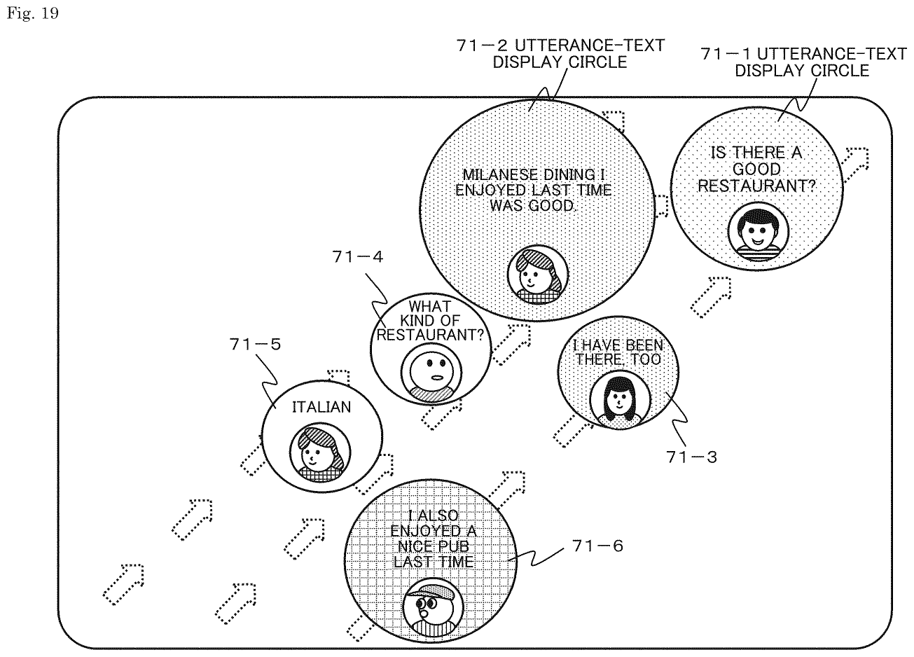

Referring to FIG. 19 and the subsequent drawings, a specific example of processing performed by the display data control unit 56, that is, a specific example of processing for representing “time-series information of user utterance” on display data will be described below.

FIG. 19 shows a specific example corresponding to the process of a. In other word, in this example, the display position of an utterance-text display circle is displayed while sequentially changing the display position.

In the example of FIG. 19, display data is similar to the display data described with reference to FIG. 2 and the utterance-text display circle 71 is displayed while being moved from the lower left to the upper right. An utterance-text display circle corresponding to the latest utterance is displayed on the lower left, and then the display circle moves to the upper right to be sequentially deleted from a display usage area on the upper right of the screen. In the example of the drawing, the utterance-text display circle 71-1 on the upper right end is an utterance-text display circle corresponding to the oldest utterance, and the utterance-text display circle 71-6 on the lower left end is an utterance-text display circle corresponding to the latest utterance.

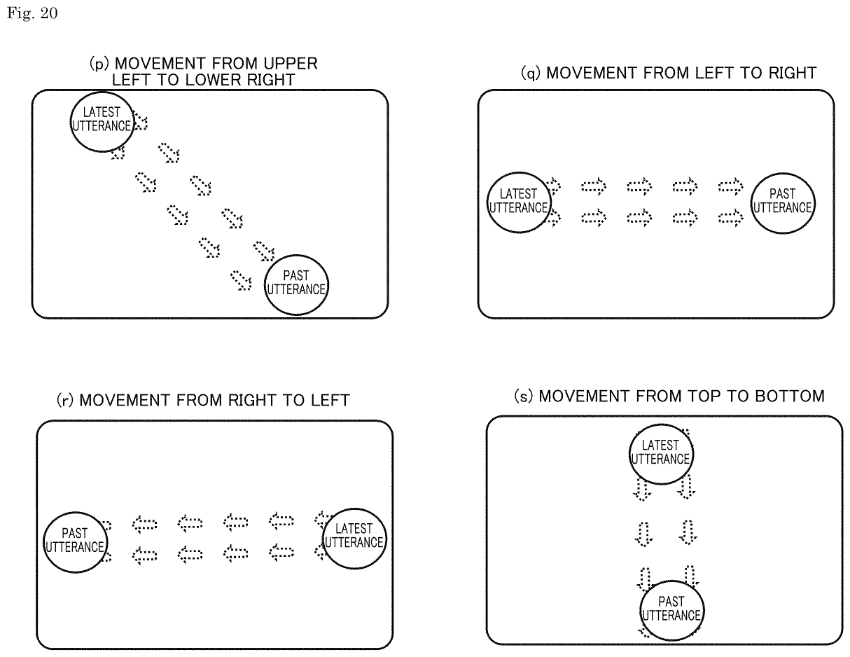

In the example of FIG. 19, the utterance-text display circle 71 is displayed while being moved from the lower left to the upper right. The moving direction is not limited to this example, and various moving directions can be set. For example, moving directions can be set as illustrated in (p) to (s) in FIG. 20.
(p) is the setting for moving the utterance-text display circle from the upper left to the lower right with the passage of time.
(q) is the setting for moving the utterance-text display circle from the left to the right with the passage of time.
(r) is the setting for moving the utterance-text display circle from the right to the left with the passage of time.
(s) is the setting for moving the utterance-text display circle from the top to the bottom with the passage of time.

Moving directions other than those in these examples can also be set.

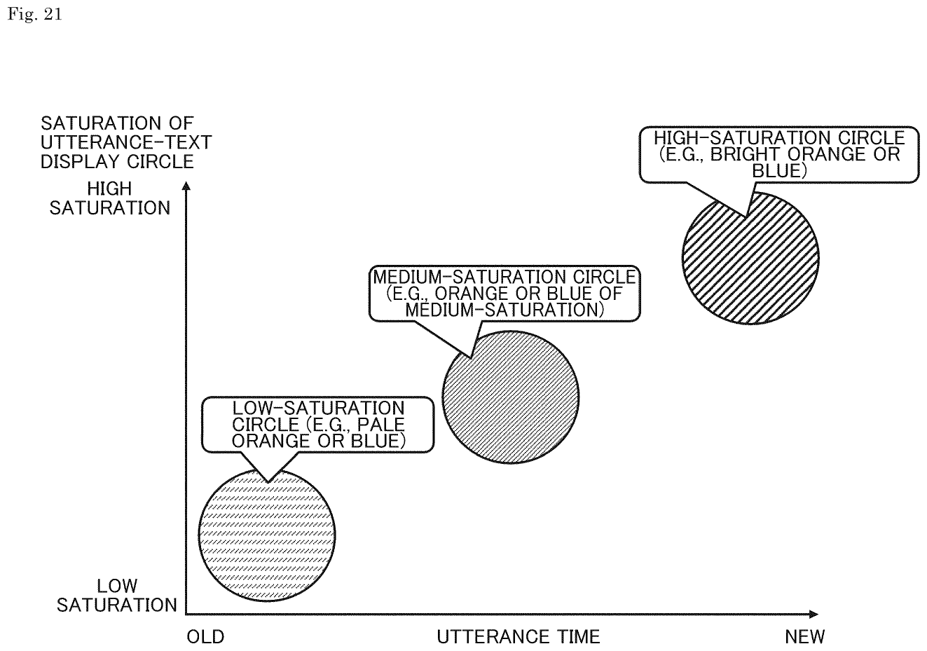

FIG. 21 shows a specific example corresponding to the process of b. In other word, in this example, the display color of an utterance-text display circle is displayed while sequentially changing the display color. The saturation of the display color is reduced as the display circle becomes old.

The graph shown in FIG. 21 is a graph that sets the time of utterance on the horizontal axis and the saturation of an utterance-text display circle on the vertical axis.

The utterance time axis on the horizontal axis is set to be old on the left side and is set to be new on the right side. The utterance time is an utterance time to be analyzed by the voice data analysis unit 53.

For example, as shown in the graph of FIG. 21, the display data control unit 56 determines the color saturation of an utterance-text display circle output onto display data, according to the utterance time analyzed by the voice data analysis unit 53.

In other words, the color saturation of the utterance-text display circle is set higher (brighter) for a new utterance time (close to the current time), whereas the color saturation of the utterance-text display circle is set lower for an old utterance time (far from the current time).

As described above, the processes a and b may be configured to be performed in combination.

Specifically, the two processes are configured to be performed in combination: process a=the display position of an utterance-text display circle is displayed while being changed sequentially and process b=the display color of an utterance-text display circle is displayed while being changed sequentially.
(5) User utterance as main utterance or dominant utterance in conversation

The information processing device (server) 50 performs display data control processing for representing, on display data, “user utterance as main utterance or dominant utterance in conversation” of a user participating in a meeting.

Data to be analyzed for display data control processing for representing “user utterance as main utterance or dominant utterance in conversation” on display data is a user utterance voice acquired by the microphone of the user terminal 21 as indicated in “(b) of item (5) in the table of FIG. 8.”

Data analysis processing performed for representing “user utterance as main utterance or dominant utterance in conversation” on display data is semantic analysis of a user utterance voice in the voice data analysis unit 53 as indicated in “(c) of item (5) in the table of FIG. 8.”

Furthermore, display data control processing performed by the display data control unit 56 to represent “user utterance as main utterance or dominant utterance in conversation” on display data is at least one of the following processes a and b as indicated in “(d) of item (5) in the table of FIG. 8.”
a. In the case of a user utterance as a main utterance or dominant utterance in conversation, the position and size of the utterance-text display circle is controlled to be displayed largely at, for example, the central part of the display region.
b. In the case of a user utterance as a main utterance or dominant utterance in conversation, “conversation center identification icon (e.g. a double-line outline circle or a solid red circle)” is displayed in contact with the utterance-text display circle.

The processes of a and b may be performed separately or in combination.

The display data control unit 56 performs at least one of the processes a and b in order to represent “user utterance as main utterance or dominant utterance in conversation” on display data.

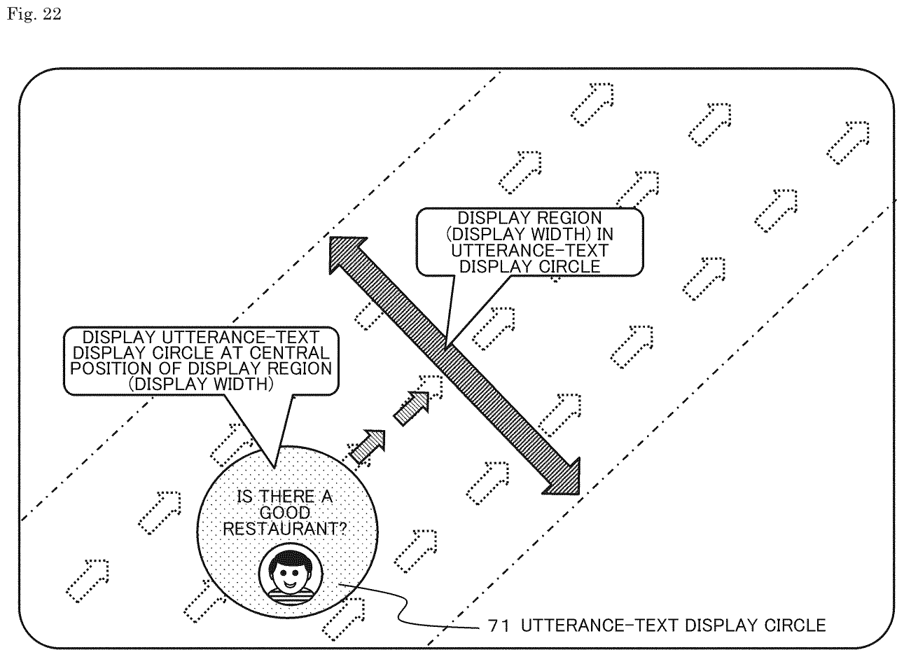

Referring to FIG. 22 and the subsequent drawings, a specific example of processing performed by the display data control unit 56, that is, a specific example of processing for representing “user utterance as main utterance or dominant utterance in conversation” on display data will be described below.

FIG. 22 shows a specific example corresponding to the process of a. Specifically, in the case of a user utterance as a main utterance or dominant utterance in conversation, the utterance-text display circle is displayed largely at the central part of the display region in the processing example.

In the example of FIG. 22, the utterance-text display circle 71 moves from the lower left to the upper right of the display region with the passage of time.

In this example, the display width of the utterance-text display circle 71 is the width of an arrow indicated in the central part of the drawing. In this case, when a user utterance is a main utterance or dominant utterance in conversation, the utterance-text display circle 71 is displayed at the central position of the display width. The utterance-text display circle 71 in the drawing moves from the lower left to the upper right of the display region with the passage of time.

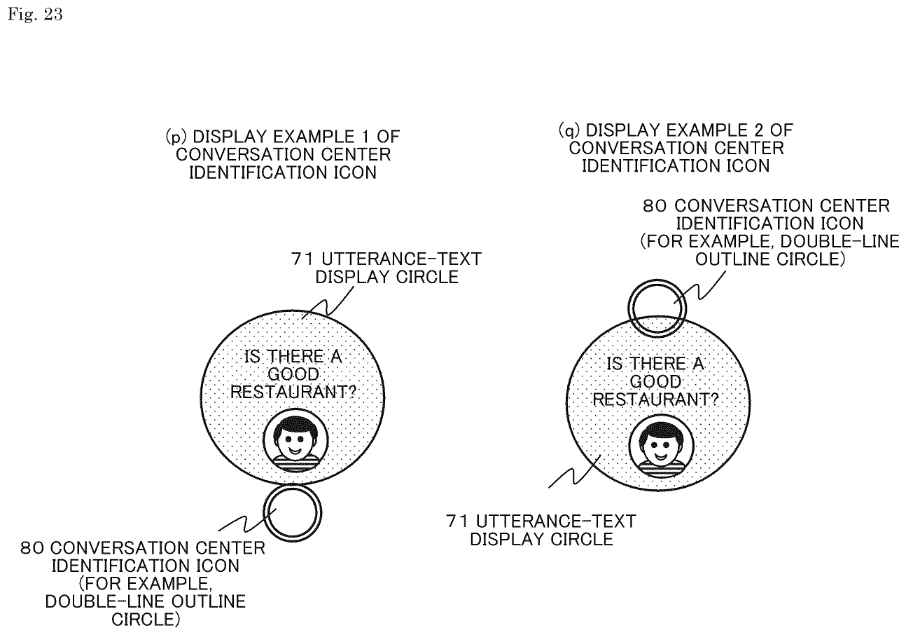

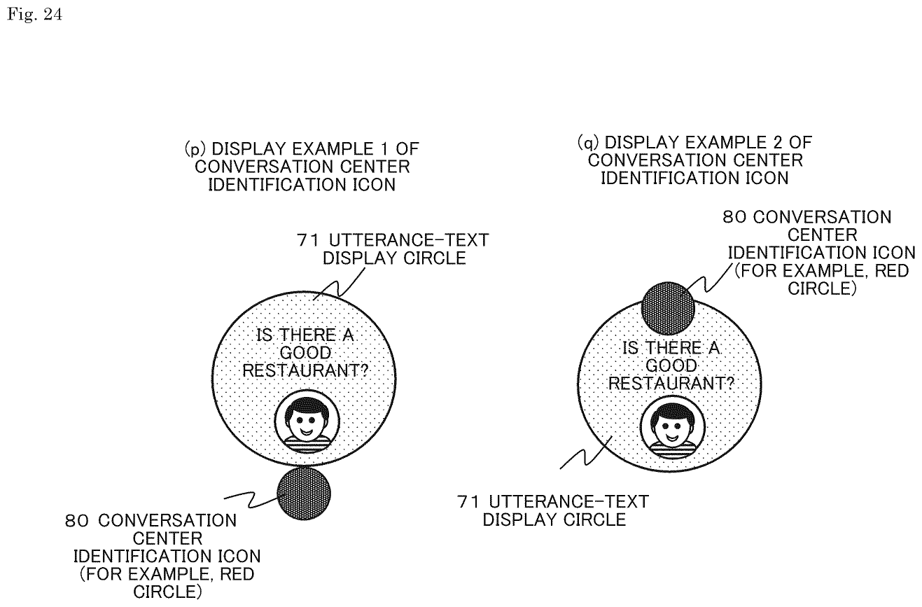

Examples shown in FIGS. 23 and 24 are specific examples corresponding to the process of b. Specifically, in the case of a user utterance as a main utterance or dominant utterance in conversation, “conversation center identification icon (e.g. a double-line outline circle or a solid red circle)” is displayed in contact with the utterance-text display circle.

The utterance-text display circle 71 in FIG. 23(p) is a main utterance or dominant utterance in conversation. In this case, “conversation center identification icon (double-line outline circle) 80” is displayed in contact with the utterance-text display circle 71.

In the example of FIG. 23(p), the conversation center identification icon (double-line outline circle) 80 is displayed in contact with the utterance-text display circle 71 serving as a main utterance or dominant utterance in conversation. For example, as shown in FIG. 23(q), the conversation center identification icon (double-line outline circle) 80 may be displayed to be superimposed on the utterance-text display circle 71 serving as a main utterance or dominant utterance in conversation.

FIG. 24 shows an example in which a solid red circle is displayed as a conversation center identification icon.

The utterance-text display circle 71 in FIG. 24(p) is a main utterance or dominant utterance in conversation. In this case, “conversation center identification icon (red circle) 80” is displayed in contact with the utterance-text display circle 71.

In the example of FIG. 24(p), the conversation center identification icon (e.g. a red circle) 80 is displayed in contact with the utterance-text display circle 71 serving as a main utterance or dominant utterance in conversation. For example, as shown in FIG. 24(q), the conversation center identification icon (red circle) 80 may be displayed to be superimposed on the utterance-text display circle 71 serving as a main utterance or dominant utterance in conversation.

As described above, the processes a and b may be configured to be performed in combination.

Specifically, the two processes may be configured to be performed in combination: process a=in the case of a user utterance as a main utterance or dominant utterance in conversation, the utterance-text display circle is displayed largely in the central part of the display region, and process b=in the case of a user utterance as a main utterance or dominant utterance in conversation, “conversation center identification icon (e.g. a double-line outline circle or a solid red circle)” is displayed in contact with the utterance-text display circle.
(6) Preceding utterance associated with user utterance

The information processing device (server) 50 performs display data control processing for representing, on display data, “preceding utterance associated with user utterance” of a user participating in a meeting.

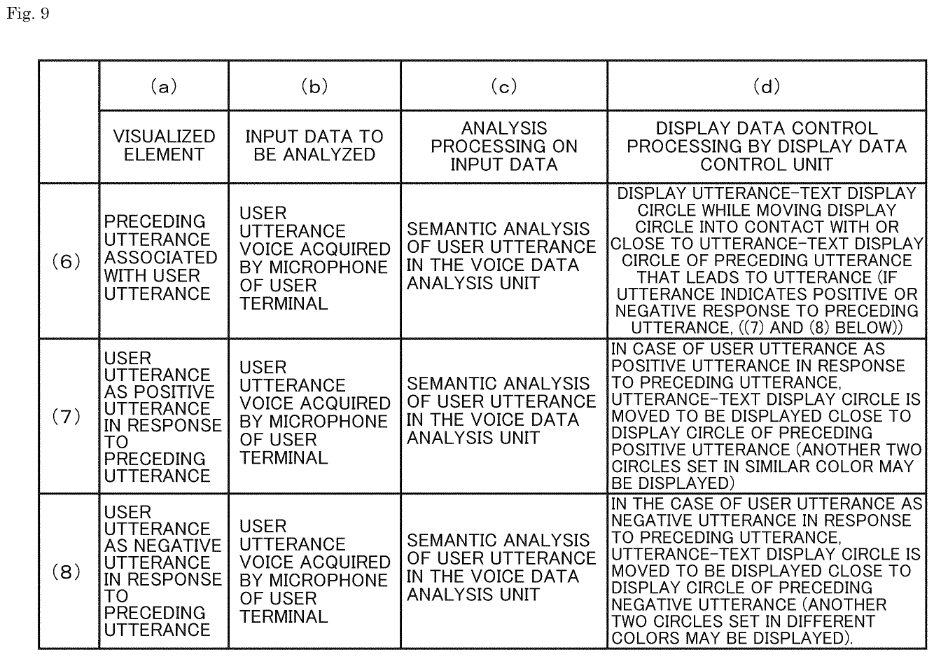

Data to be analyzed for display data control processing for representing “preceding utterance associated with user utterance” on display data is a user utterance voice acquired by the microphone of the user terminal 21 as indicated in “(b) of item (6) in the table of FIG. 9.”

Data analysis processing performed for representing “preceding utterance associated with user utterance” on display data is semantic analysis of a user utterance voice in the voice data analysis unit 53 as indicated in “(c) of item (6) in the table of FIG. 9.”

Furthermore, display data control processing performed by the display data control unit 56 to represent “preceding utterance associated with user utterance” on display data is the following processing as indicated in “(d) of item (6) in the table of FIG. 9.”

The utterance-text display circle is displayed while being moved into contact with or close to the utterance-text display circle of a preceding utterance that leads to the utterance. However, if the utterance indicates a positive or negative response to the preceding utterance, the display control of (7) and (8) described later is preferentially performed.

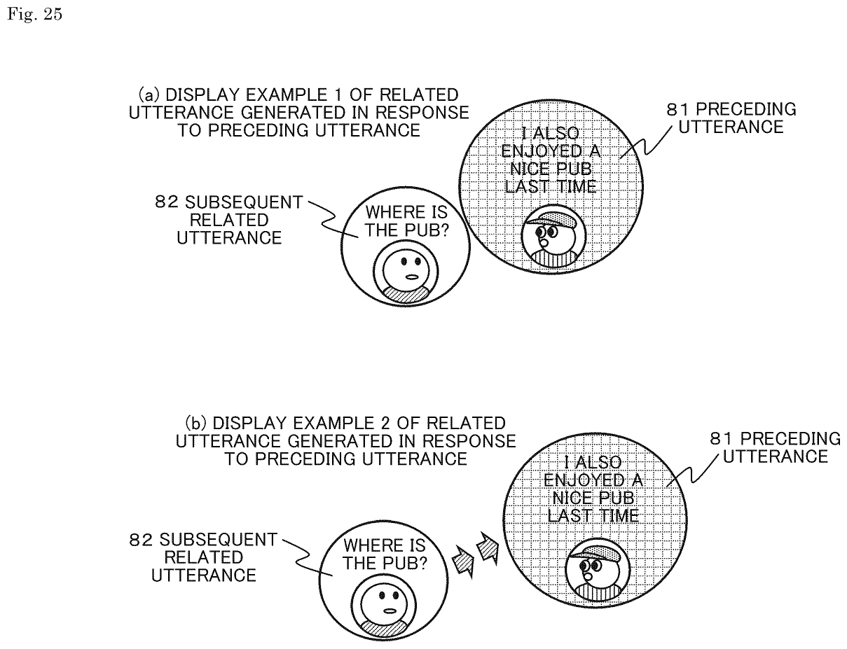

Referring to FIG. 25 and the subsequent drawings, a specific example of processing performed by the display data control unit 56, that is, a specific example of processing for representing “preceding utterance associated with user utterance” on display data will be described below.

FIG. 25(a) illustrates an example of processing performed by the display data control unit 56.

In the display example of FIG. 25(a), an utterance-text display circle 82 of a subsequent related utterance is displayed in contact with an utterance-text display circle 81 of a preceding utterance.

FIG. 25(b) also illustrates an example of processing performed by the display data control unit 56.

In the display example of FIG. 25(b), the utterance-text display circle 82 of the subsequent related utterance is moved to be displayed close to the utterance-text display circle 81 of the preceding utterance.

The contact illustrated in FIG. 25(a) may be displayed after the movement illustrated in FIG. 25(b) is displayed.

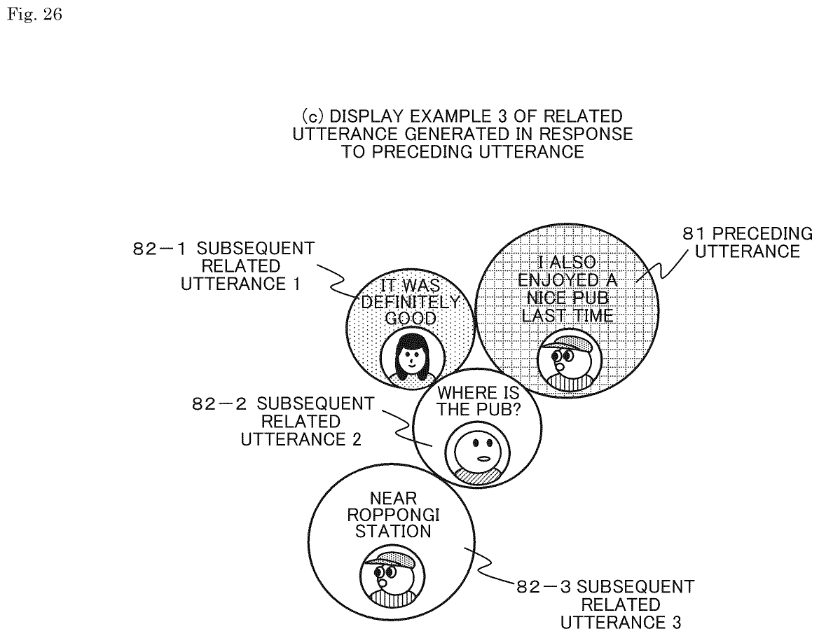

FIG. 26(c) also illustrates an example of processing performed by the display data control unit 56.

The display example of FIG. 26(c) is a display example in which multiple related utterances are generated in response to a preceding utterance.

In response to the utterance-text display circle 81 of the preceding utterance, the utterance-text display circles of two subsequent related utterances are shown.

Specifically,
an utterance-text display circle 82-1 of a first subsequent related utterance and
an utterance-text display circle 82-2 of a second subsequent related utterance are shown.

In such a case, as illustrated in FIG. 26, the display data control unit 56 displays the utterance-text display circles 82-1 and 82-2 of the subsequent related utterances side by side on the circumference of the utterance-text display circle 81 of the preceding utterance.

Furthermore, the example of FIG. 26 shows an utterance-text display circle 82-3 of a related utterance generated in response to the utterance-text display circle 82-2 of the subsequent related utterance.

The utterance shown in the utterance-text display circle 82-3 is a related utterance generated in response to the utterance-text display circle 82-2 of the subsequent related utterance and is displayed in contact with the utterance-text display circle 82-2.
(7) User utterance as positive utterance generated in response to preceding utterance

The information processing device (server) 50 performs display data control processing for representing, on display data, “user utterance as positive utterance in response to preceding utterance” of a user participating in a meeting.

Data to be analyzed for display data control processing for representing “user utterance as positive utterance in response to preceding utterance” on display data is a user utterance voice acquired by the microphone of the user terminal 21 as indicated in “(b) of item (7) in the table of FIG. 9.”

Data analysis processing performed for representing “user utterance as positive utterance in response to preceding utterance” on display data is semantic analysis of a user utterance voice in the voice data analysis unit 53 as indicated in “(c) of item (7) in the table of FIG. 9.”

Furthermore, display data control processing performed by the display data control unit 56 to represent “user utterance as positive utterance in response to preceding utterance” on display data is the following processing as indicated in “(d) of item (7) in the table of FIG. 9.”

In the case of a user utterance as a positive utterance in response to a preceding utterance, the utterance-text display circle is moved to be displayed close to the display circle of a preceding positive utterance (another two circles set in a similar color may be displayed).

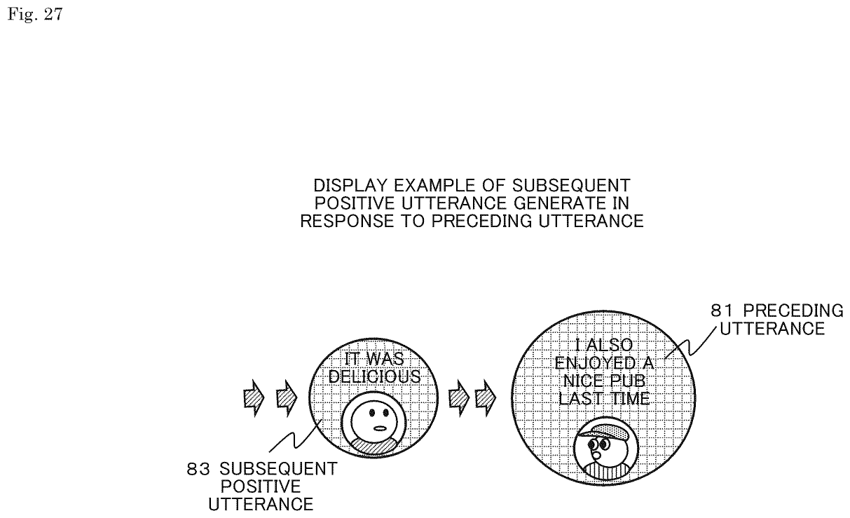

Referring to FIG. 27, a specific example of processing performed by the display data control unit 56, that is, a specific example of processing for representing “user utterance as positive utterance in response to preceding utterance” on display data will be described below.

FIG. 27 shows the utterance-text display circle 81 of the preceding utterance and an utterance-text display circle 83 of a subsequent positive utterance.

The utterance-text display circle 83 of the subsequent positive utterance is moved to be displayed close to the utterance-text display circle 81 of the preceding utterance.

Along with this processing, the utterance-text display circle 83 of the subsequent positive utterance may be controlled to be set in the same color as the utterance-text display circle 81 of the preceding utterance or in a similar color.
(8) User utterance as negative utterance generated in response to preceding utterance

The information processing device (server) 50 performs display data control processing for representing, on display data, “user utterance as negative utterance in response to preceding utterance” of a user participating in a meeting.

Data to be analyzed for display data control processing for representing “user utterance as negative utterance in response to preceding utterance” on display data is a user utterance voice acquired by the microphone of the user terminal 21 as indicated in “(b) of item (8) in the table of FIG. 9.”

Data analysis processing performed for representing “user utterance as negative utterance in response to preceding utterance” on display data is semantic analysis of a user utterance voice in the voice data analysis unit 53 as indicated in “(c) of item (8) in the table of FIG. 9.”

Furthermore, display data control processing performed by the display data control unit 56 to represent “user utterance as negative utterance in response to preceding utterance” on display data is the following processing as indicated in “(d) of item (8) in the table of FIG. 9.”

In the case of a user utterance as a negative utterance in response to a preceding utterance, the utterance-text display circle is moved to be displayed close to the display circle of a preceding negative utterance (another two circles set in different colors such as opposite colors may be displayed).

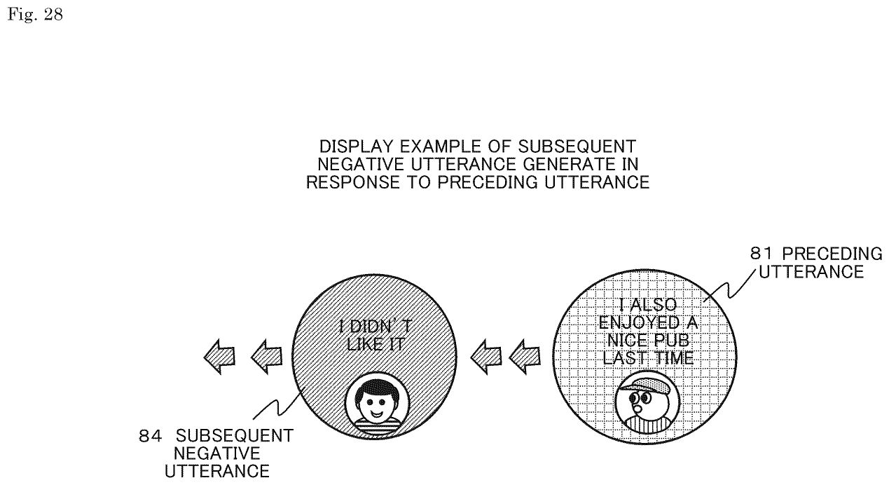

Referring to FIG. 28, a specific example of processing performed by the display data control unit 56, that is, a specific example of processing for representing “user utterance as negative utterance in response to preceding utterance” on display data will be described below.

FIG. 28 shows the utterance-text display circle 81 of the preceding utterance and an utterance-text display circle 84 of a subsequent negative utterance.

The utterance-text display circle 84 of the subsequent negative utterance is moved to be displayed remote from the utterance-text display circle 81 of the preceding utterance.

Along with this processing, the utterance-text display circle 84 of the subsequent negative utterance may be controlled to be set in an opposite color or a different color from the color of the utterance-text display circle 81 of the preceding utterance.
(9) Positive action of user

The information processing device (server) 50 performs display data control processing for representing, on display data, “positive action of user” of a user participating in a meeting.

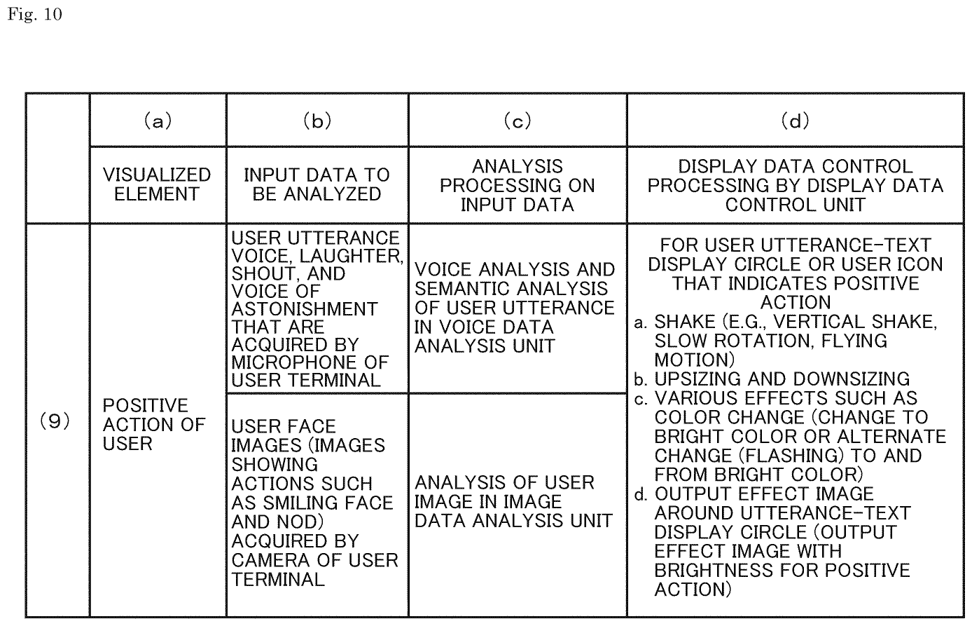

Data to be analyzed for display data control processing for representing “positive action of user” on display data is a user utterance voice, laughter, shout, and a voice of astonishment that are acquired by the microphone of the user terminal 21 and user face images including a smiling face and a nod that are acquired by the camera of the user terminal 21 as indicated in “(b) of item (9) in the table of FIG. 10.”

Data analysis processing performed for representing “positive action of user” on display data is voice analysis and semantic analysis of a user utterance in the voice data analysis unit 53 and analysis processing on user images in the image data analysis unit 55 as indicated in “(c) of item (9) in the table of FIG. 10.”

Furthermore, display data control processing performed by the display data control unit 56 to represent “positive action of user” on display data is the following processing as indicated in “(d) of item (9) in the table of FIG. 10.” Specifically, for a user utterance-text display circle or a user icon that indicates a positive action, display control is performed according to any one of a to d below.
a. Shake (e.g., vertical shake, slow rotation, flying motion)
b. Upsizing and downsizing
c. Color change (change to bright color or alternate change (flashing) to and from bright color)
d. Output effect image around utterance-text display circle (output effect image with brightness for positive action)

These processes of a, b, c, and d may be set to be performed separately or in combination.

The display data control unit 56 performs at least one of the processes a, b, c, and d in order to represent “positive action of user” on display data.

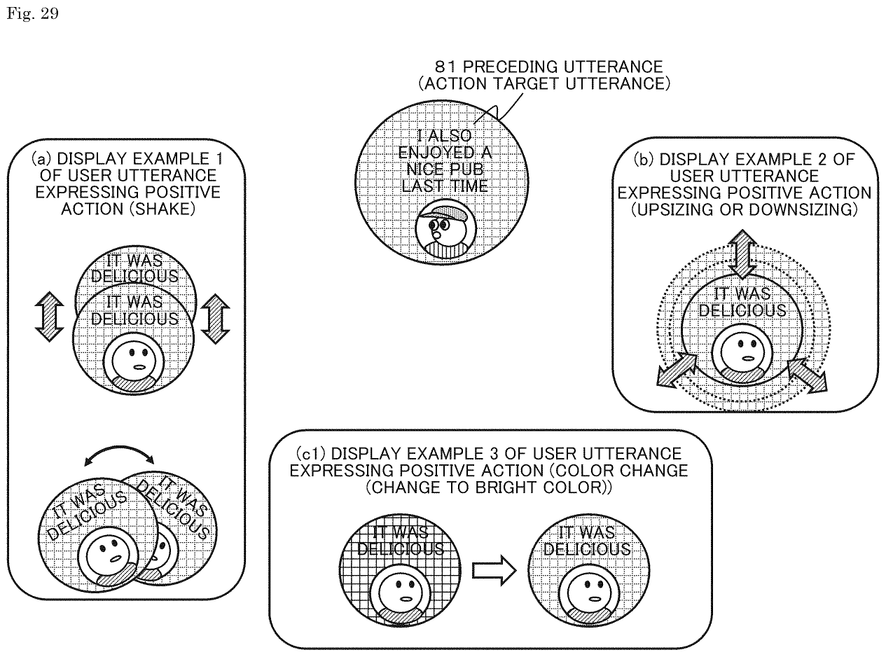

Referring to FIG. 29, a specific example of processing performed by the display data control unit 56, that is, a specific example of processing for representing “positive action of user” on display data will be described below.

FIG. 29 illustrates the utterance-text display circle 81 of a preceding utterance that motivates a positive action of a user and display data examples (a) to (c1), which correspond to the processes a, b, and c, as display data examples of “positive action of user.”

FIG. 29(a) is a display control example corresponding to “a. shake (e.g., vertical shake, slow rotation, flying motion).” FIG. 29(a) illustrates a display control example in which an utterance-text display circle is shaken vertically for a user having expressed a positive action and a display control example in which an utterance-text display circle is shaken in the direction of rotation.

FIG. 29(b) is a display control example corresponding to “b. upsizing and downsizing.” FIG. 29(b) illustrates a display control example in which an utterance-text display circle is upsized or downsized to be displayed for a user having expressed a positive action.

FIG. 29(c1) is a display control example corresponding to “c. color change (a change to a bright color).” FIG. 29(c1) illustrates a display control example in which an utterance-text display circle is changed to a bright color for a user having expressed a positive action.

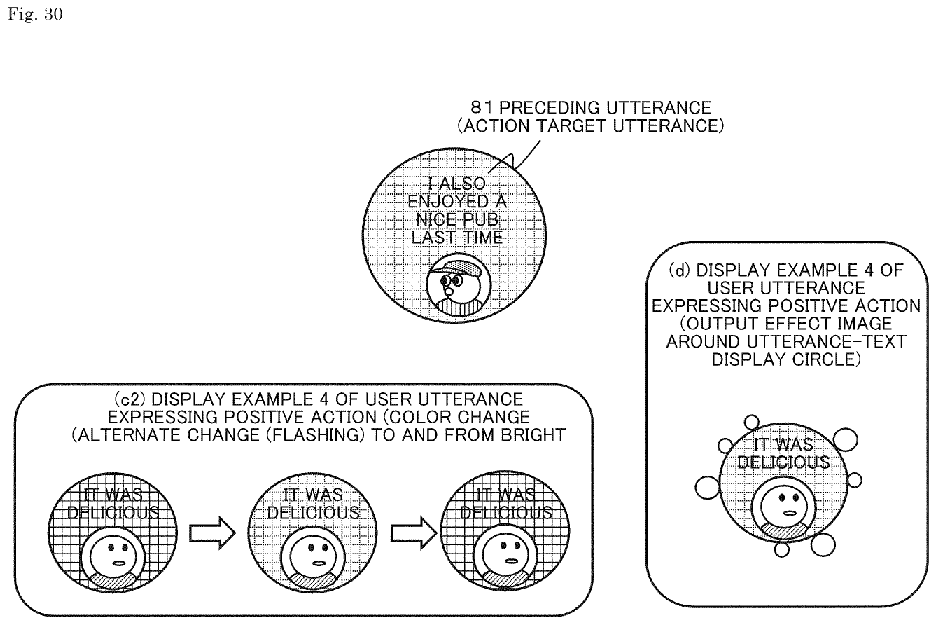

FIG. 30 shows display data examples (c2) to (d) corresponding to the processes of c and d.

FIG. 30 illustrates the utterance-text display circle 81 of a preceding utterance that motivates a positive action of a user and the display data examples (c2) to (d) of “positive action of user.”

FIG. 30(c2) is a display control example corresponding to “c. color change (an alternate change (flashing) to and from a bright color).” FIG. 30(c2) illustrates a display control example in which the color of an utterance-text display circle for a user having expressed a positive action is temporarily changed to a bright color. For example, display control is performed to make a change to a bright color for a moment, e.g., for a second or two or flashing is performed to alternately display the original color and a bright color.

FIG. 30(d) is a display control example corresponding to “d. output effect image around utterance-text display circle (output effect image with brightness for positive action).” FIG. 30(d) illustrates an example of output of an effect image with brightness as an example of output of an effect image around the utterance-text display circle of a user having expressed a positive action.
(10) Negative action of user

The information processing device (server) 50 performs display data control processing for representing, on display data, “negative action of user” of a user participating in a meeting.

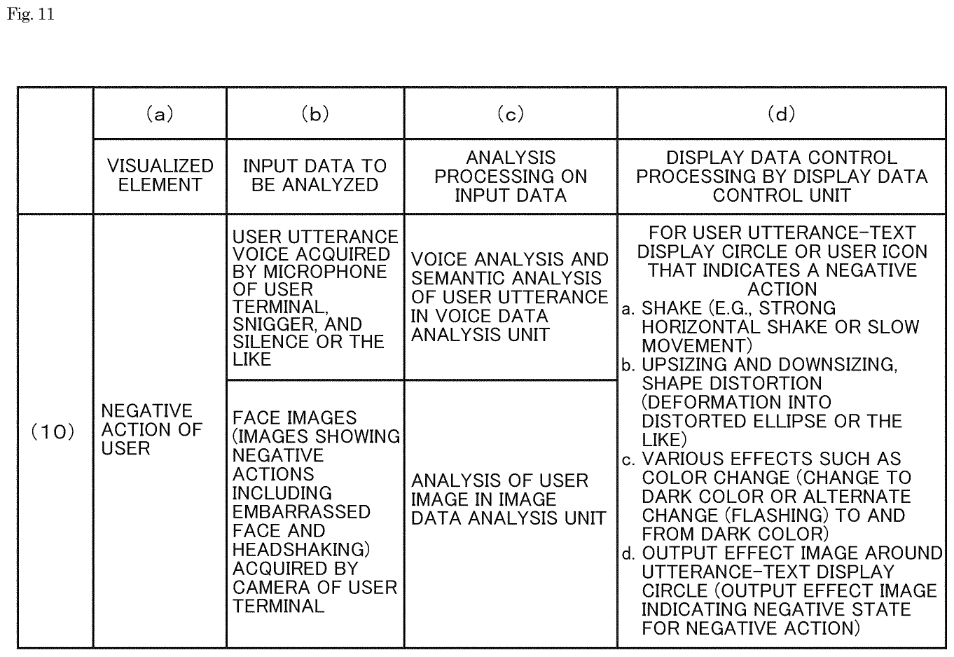

Data to be analyzed for display data control processing for representing “negative action of user” on display data is a user utterance voice acquired by the microphone of the user terminal 21, a snigger, and silence or the like and user face images including an embarrassed face and headshaking that are acquired by the camera of the user terminal 21 as indicated in “(b) of item (10) in the table of FIG. 11.”

Data analysis processing performed for representing “negative action of user” on display data is voice analysis and semantic analysis of a user utterance in the voice data analysis unit 53 and analysis processing on user images in the image data analysis unit 55 as indicated in “(c) of item (10) in the table of FIG. 11.”

Furthermore, display data control processing performed by the display data control unit 56 to represent “negative action of user” on display data is the following processing as indicated in “(d) of item (10) in the table of FIG. 11.” Specifically, for a user utterance-text display circle or a user icon that indicates a negative action, display control is performed according to any one of a to c below.
a. Shake (e.g., strong horizontal shake or slow movement)
b. Upsizing and downsizing, shape distortion (deformation into distorted ellipse or the like)
c. Color change (change to dark color or alternate change (flashing) to and from dark color)
d. Output effect image around utterance-text display circle (output effect image indicating negative state for negative action)

These processes of a, b, c, and d may be set to be performed separately or in combination.

The display data control unit 56 performs at least one of the processes a, b, c, and d in order to represent “negative action of user” on display data.

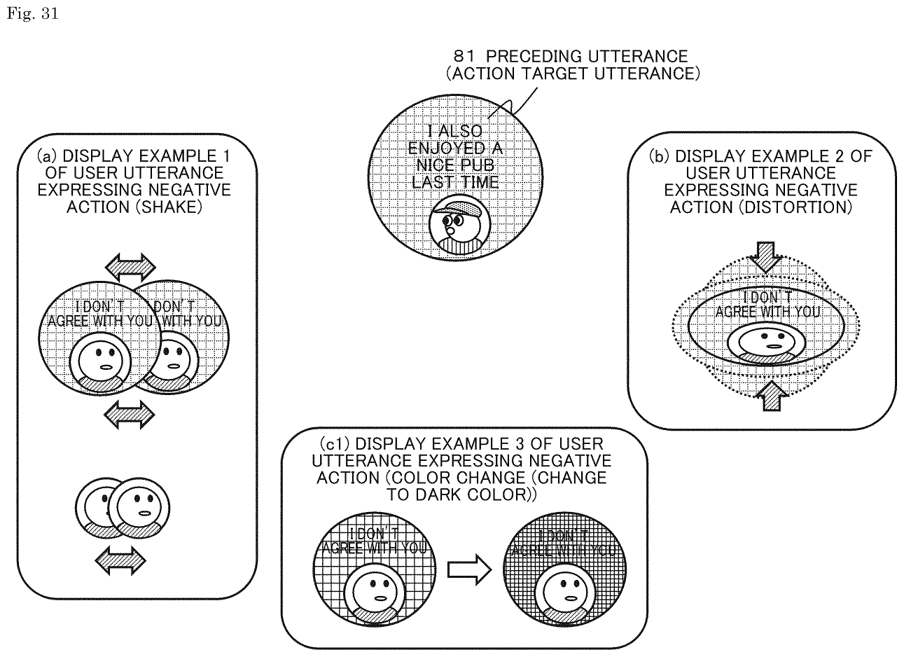

Referring to FIG. 31, a specific example of processing performed by the display data control unit 56, that is, a specific example of processing for representing “negative action of user” on display data will be described below.

FIG. 31 illustrates the utterance-text display circle 81 of a preceding utterance that motivates a negative action of a user and display data examples (a) to (c1), which correspond to the processes a, b, and c, as display data examples of “negative action of user.”

FIG. 31(a) is a display control example corresponding to “shake (e.g., strong horizontal shake).” FIG. 31(a) illustrates a display control example in which an utterance-text display circle and a user icon are strongly shaken horizontally for a user having expressed a negative action.

FIG. 31(b) is a display control example corresponding to “b. upsizing and downsizing, shape distortion (deformation into distorted ellipse or the like).”

FIG. 31(b) illustrates a display control example in which an utterance-text display circle for a user having expressed a negative action is displayed while being deformed into a distorted ellipse.

FIG. 31(c1) is a display control example corresponding to “c. color change (change to dark color).” FIG. 31(c1) illustrates a display control example in which an utterance-text display circle is changed to a dark color for a user having expressed a negative action.

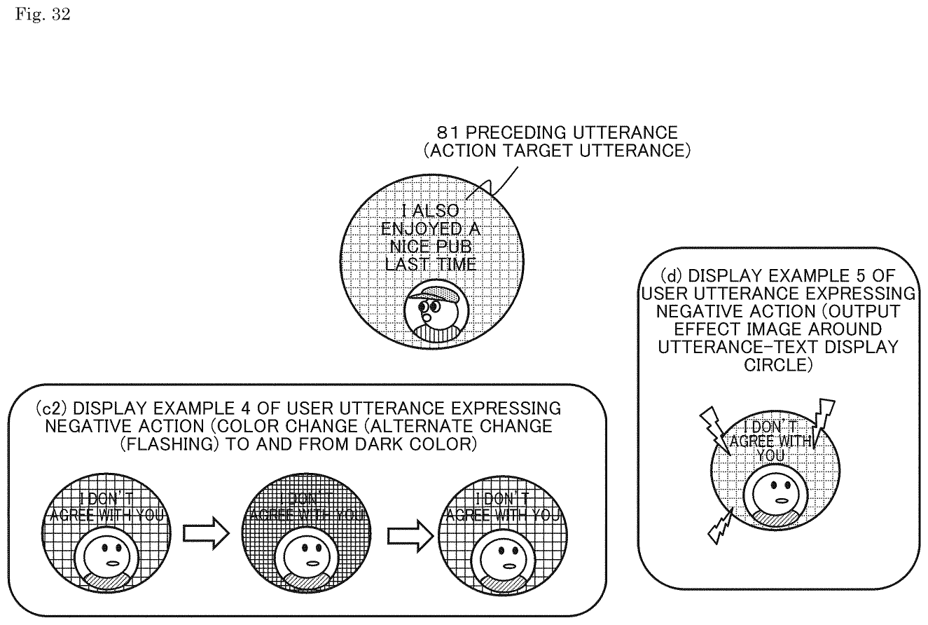

FIG. 32 shows display data examples (c2) to (d) corresponding to the processes of c and d.

FIG. 32 illustrates the utterance-text display circle 81 of a preceding utterance that motivates a negative action of a user and the display data examples (c2) to (d) of “negative action of user.”

FIG. 32(c2) is a display control example corresponding to “c. color change (alternate change (flashing) to and from dark color).” FIG. 32(c2) illustrates a display control example in which the color of an utterance-text display circle for a user having expressed a negative action is temporarily changed to a dark color.

For example, display control is performed to make a change to a dark color for a moment, e.g., for a second or two or flashing is performed to alternately display the original color and a dark color.

FIG. 32(d) is a display control example corresponding to “d. output effect image around utterance-text display circle (output effect image indicating negative state for negative action).” FIG. 32(d) illustrates an example of output of an effect image indicating a negative state as an example of output of an effect image around the utterance-text display circle of a user having expressed a negative action.
(11) Excitement in overall conversation

The information processing device (server) 50 performs display data control processing for representing, on display data, “excitement in overall conversation” of a user participating in a meeting.

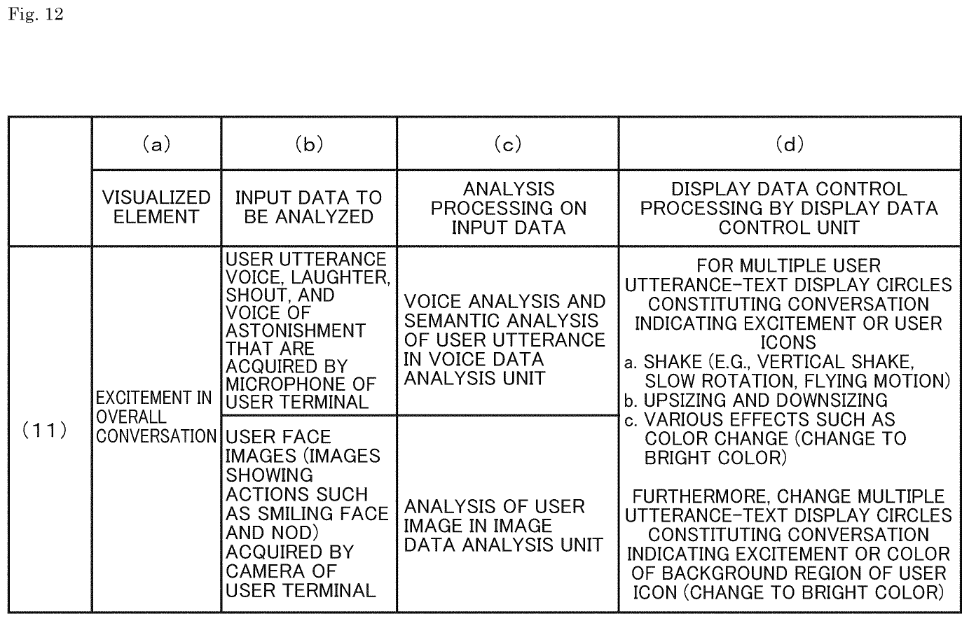

Data to be analyzed for display data control processing for representing “excitement in overall conversation” on display data is a user utterance voice, laughter, shout, and a voice of astonishment that are acquired by the microphone of the user terminal 21 and user face images including a smiling face and a nod that are acquired by the camera of the user terminal 21 as indicated in “(b) of item (11) in the table of FIG. 12.”

Data analysis processing performed for representing “excitement in overall conversation” on display data is voice analysis and semantic analysis of a user utterance in the voice data analysis unit 53 and analysis processing on user images in the image data analysis unit 55 as indicated in “(c) of item (11) in the table of FIG. 12.”

Furthermore, display data control processing performed by the display data control unit 56 to represent “excitement in overall conversation” on display data is the following processing as indicated in “(d) of item (11) in the table of FIG. 12.” Specifically, for multiple user utterance-text display circles constituting a conversation indicating excitement or user icons, display control is performed according to any one of a to c below.
a. Shake (e.g., vertical shake, slow rotation, flying motion)
b. Upsizing and downsizing
c. Color change (change to bright color)

These processes of a, b, and c may be set to be performed separately or in combination.

These processes are the same as those of the display control processing for “(9) positive action of user” described with reference to FIG. 29.

Furthermore, as unique processing for representing “excitement in overall conversation” on display data, the display data control unit 56 may perform display data control processing as follows:

Display control processing is performed to change multiple utterance-text display circles constituting a conversation indicating excitement or the color of the background region of the user icon (change to a bright color).

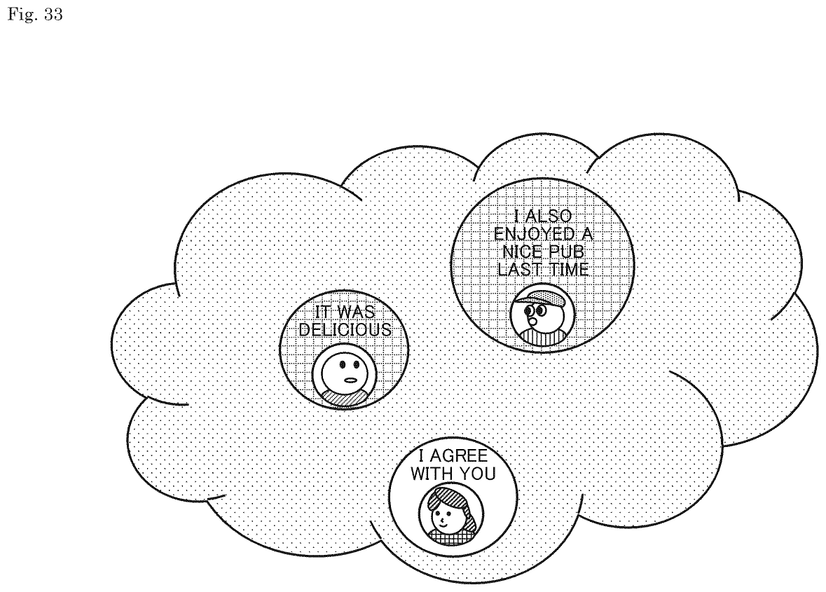

A specific example of this processing will be described with reference to FIG. 33.

FIG. 33 shows multiple utterance-text display circles. When it is determined that a conversation including the utterances shows a high level of excitement, the display data control unit 56 performs display control processing for changing the color of the background region of the utterance-text display circles (change to a bright color) as shown in FIG. 33.

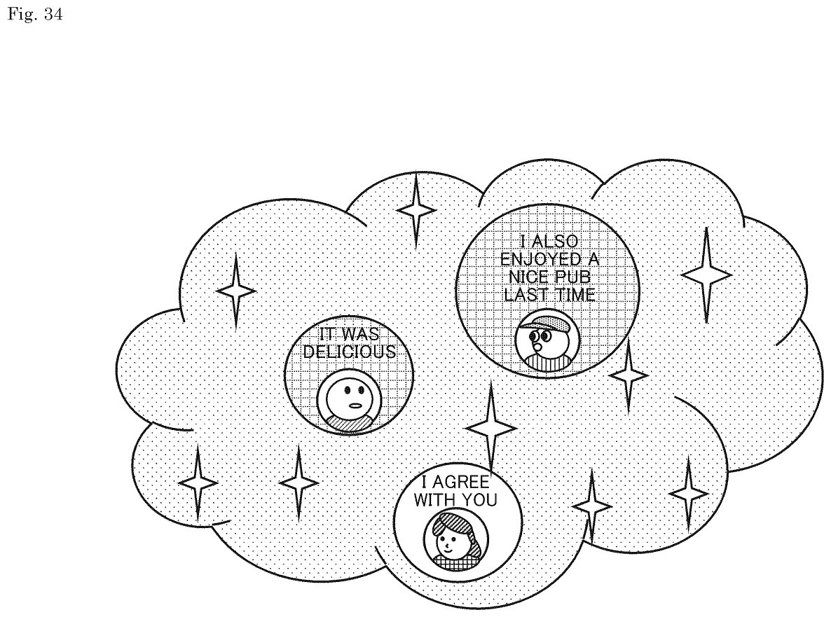

Furthermore, as shown in FIG. 34, control may be performed to change the color of the background region of the utterance-text display circles (change to a bright color) and display an effect image indicating brightness or the like.
(12) Decreasing excitement in overall conversation

The information processing device (server) 50 performs display data control processing for representing, on display data, “decreasing excitement in overall conversation” of a user participating in a meeting.

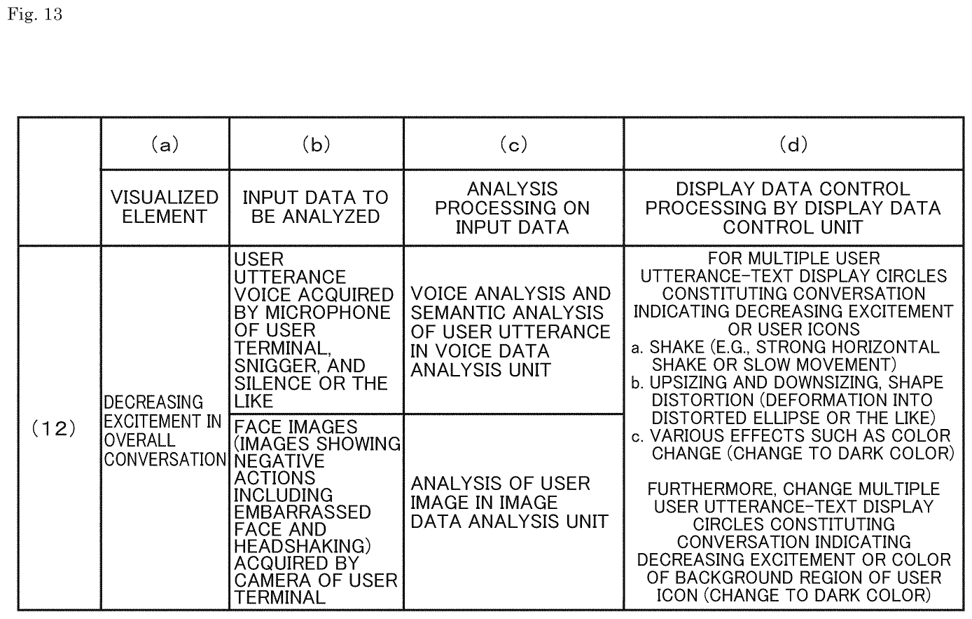

Data to be analyzed for display data control processing for representing “decreasing excitement in overall conversation” on display data is a user utterance voice acquired by the microphone of the user terminal 21, a snigger, and silence or the like and user face images including an embarrassed face and headshaking that are acquired by the camera of the user terminal 21 as indicated in “(b) of item (12) in the table of FIG. 13.”

Data analysis processing performed for representing “decreasing excitement in overall conversation” on display data is voice analysis and semantic analysis of a user utterance in the voice data analysis unit 53 and analysis processing on user images in the image data analysis unit 55 as indicated in “(c) of item (12) in the table of FIG. 13.”

Furthermore, display data control processing performed by the display data control unit 56 to represent “decreasing excitement in overall conversation” on display data is the following processing as indicated in “(d) of item (12) in the table of FIG. 13.”

Specifically, for multiple user utterance-text display circles constituting a conversation indicating decreasing excitement or user icons, display control is performed according to any one of a to c below.
a. Shake (e.g., strong horizontal shake or slow movement)
b. Upsizing and downsizing, shape distortion into distorted ellipse or the like)
c. Color change (change to dark color)

These processes of a, b, and c may be set to be performed separately or in combination.

These processes are the same as those of the display control processing for “(9) negative action of user” described with reference to FIG. 31.

Furthermore, as unique processing for representing “decreasing excitement in overall conversation” on display data, the display data control unit 56 may perform display data control processing as follows:

Display control processing is performed to change multiple user utterance-text display circles constituting conversation indicating decreasing excitement or the color of the background region of the user icon (change to a dark color).

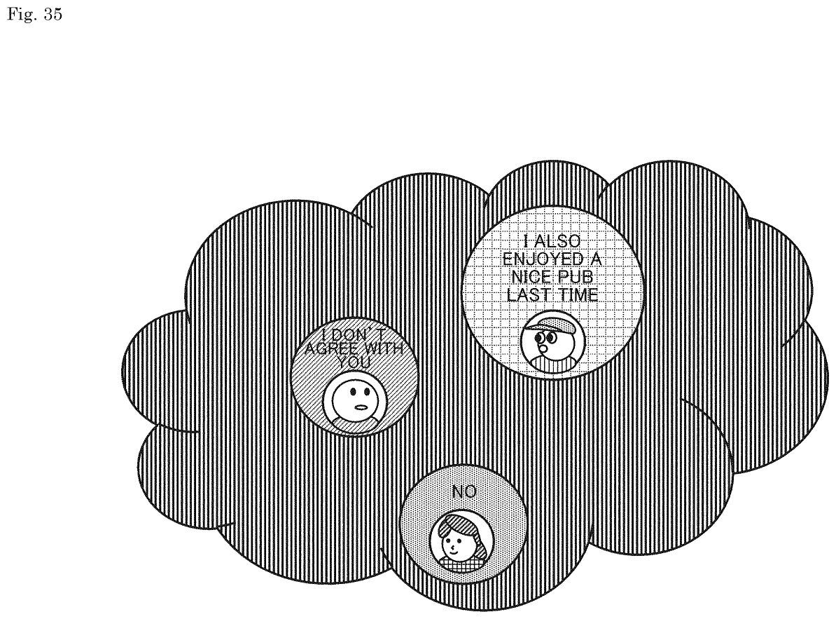

A specific example of this processing will be described with reference to FIG. 35.

FIG. 35 shows multiple utterance-text display circles. When it is determined that a conversation including the utterances shows decreasing excitement, the display data control unit 56 performs display control processing for changing the color of the background region of the utterance-text display circles (change to a dark color) as shown in FIG. 35.

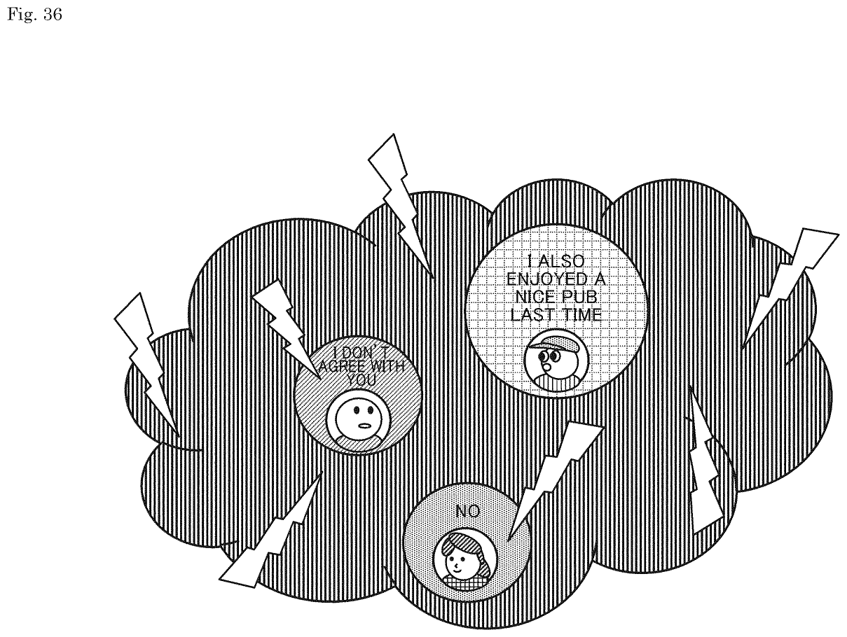

Furthermore, as shown in FIG. 36, control may be performed to change the color of the background region of the utterance-text display circles (change to a dark color) and display an effect image indicating decreasing excitement.
(13) Classification of opinions

The information processing device (server) 50 performs display data control processing for representing, on display data, “classification of opinions” of a user participating in a meeting.

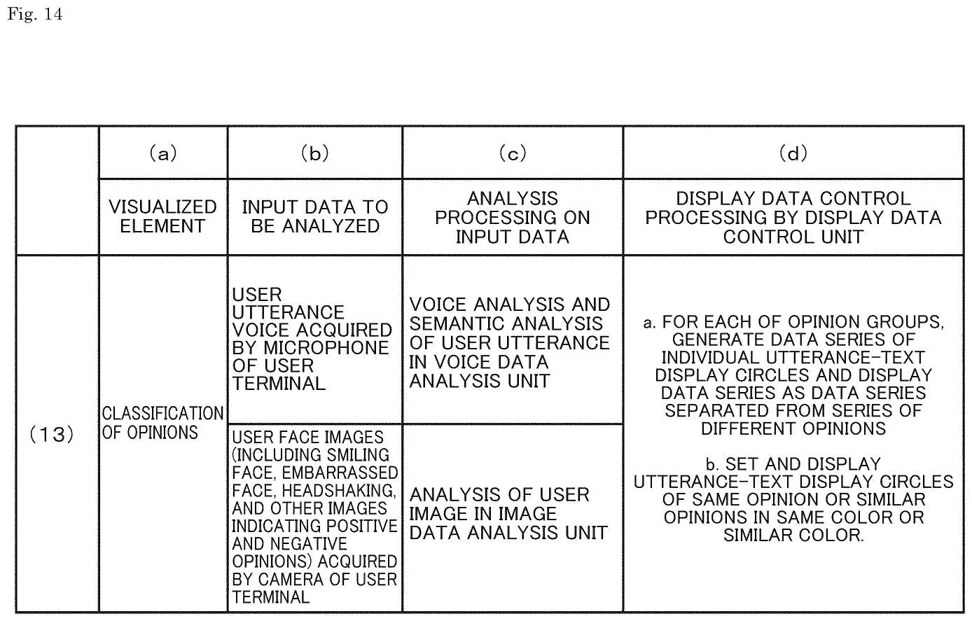

Data to be analyzed for display data control processing for representing “classification of opinions” on display data is a user utterance voice acquired by the microphone of the user terminal 21 and user face images including a smiling face, an embarrassed face, headshaking, and other images indicating positive and negative opinions, the face images being acquired by the camera of the user terminal 21 as indicated in “(b) of item (13) in the table of FIG. 14.”

Data analysis processing performed for representing “classification of opinions” on display data is voice analysis and semantic analysis of a user utterance in the voice data analysis unit 53 and analysis processing on user images in the image data analysis unit 55 as indicated in “(c) of item (13) in the table of FIG. 14.”

Furthermore, display data control processing performed by the display data control unit 56 to represent “classification of opinions” on display data is the following processing as indicated in “(d) of item (13) in the table of FIG. 14.”
a. For each of opinion groups, a data series of individual utterance-text display circles is generated and displayed as a data series separated from a series of different opinions.
b. Utterance-text display circles of the same opinion or similar opinions are set and displayed in the same color or a similar color.

These processes of a and b may be set to be performed separately or in combination.

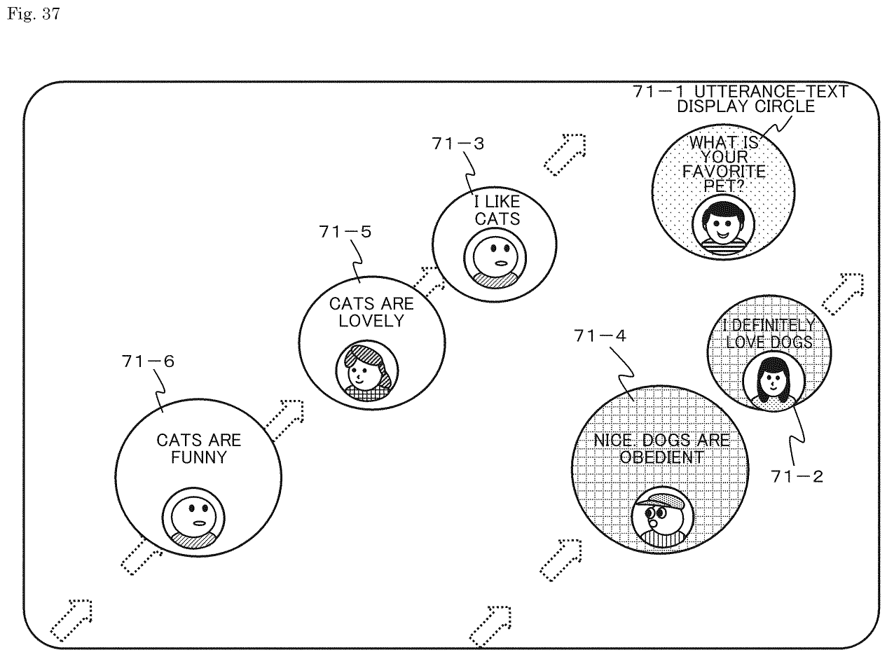

FIG. 37 shows a specific example of display control processing performed by the display data control unit 56 the information processing device (server) 50.

FIG. 37 shows multiple utterance-text display circles. The utterance-text display circle 71-1 is an utterance for requesting user opinions as follows:
Utterance=“What is your favorite pet?”

As illustrated in FIG. 37, it is assumed that two groups of dog lovers and cat lovers are set for this utterance.

An utterance-text display circle 71-2 and an utterance-text display circle 71-4 are the user utterances of the dog lover group.

An utterance-text display circle 71-3, an utterance-text display circle 71-5, and an utterance-text display circle 71-6 are the user utterances of the cat lover group.

In such a case, the display data control unit 56 generates and displays a data series of the individual utterance-text display circles for each group. In other words, as shown in FIG. 37, the utterance-text display circle 71-2 and the utterance-text display circle 71-4 as the user utterances of the dog lover group are arranged next to each other.

The utterance-text display circle 71-3, the utterance-text display circle 71-5, and the utterance-text display circle 71-6 as the user utterances of the cat lover group are arranged remote from the utterance circles of the dog lover group.

Such display facilitates identification of the group of user opinions.

### 4. Display Data Control Processing in User Terminal

Display data control processing in the user terminal will be described below.

As described above with reference to FIG. 1 or other drawings, the user 11 in a remote meeting can participate in the meeting while viewing display data including time series data of the utterance-text display circles 71 in FIG. 2 by using the user terminals 21 used by the users.

As described above, display data displayed on the user terminals 21 of the users 11 is display data generated by the information processing device (server) 50 that provides the platform of a remote meeting and performs management processing for the meeting.

In addition, the users 11 can perform display control on display data provided from the information processing device (server) 50, by using the user terminals 21.

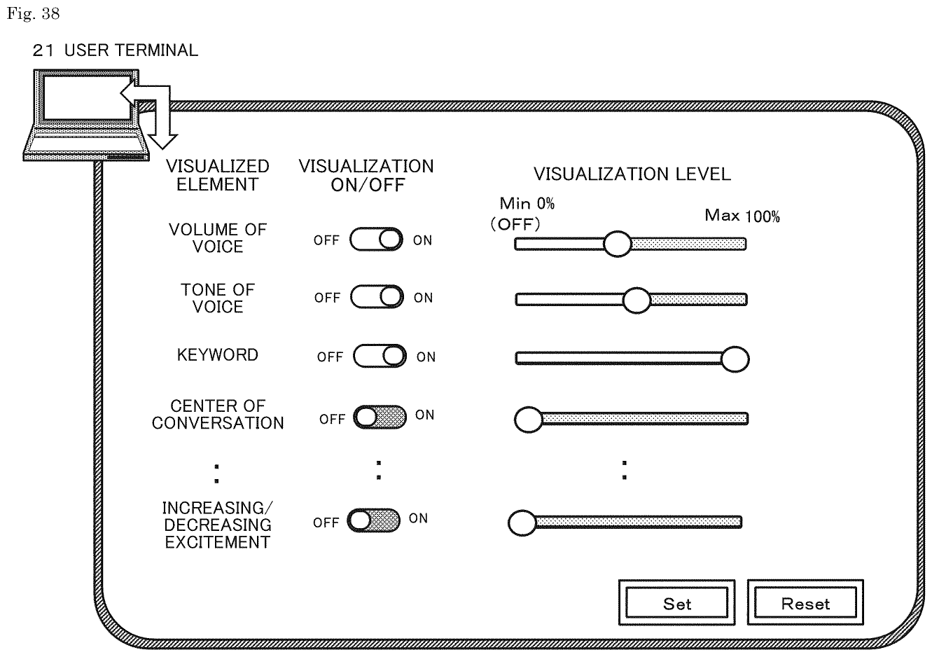

Referring to FIG. 38, an example of display data control processing using the user terminals 21 by the users 11 will be described below.

FIG. 38 shows an example of a UI (user interface) for controlling display data displayed on the user terminal 21 used by the user 11.

The UI (user interface) in FIG. 38 is a UI (user interface) that sets whether to enable (ON) or disable (OFF) the setting of visualization for visualized elements and allows the setting of a visualization level (Min to Max) for the visualized element enabled (ON) to be set.

In the example of the drawing, for example, the setting of “visualized element=voice volume” is enabled (ON), and the level of visualization is set at about 50%. In this case, display data is generated in the information processing device (server) 50 such that the enlargement ratio of the utterance-text display circle according to the volume of a user utterance voice is reduced to 50% as described with reference to FIG. 15. The user can view the display data generated thus.

Furthermore, for example, the settings of “visualized element=center of conversation” and “visualized element=excitement of conversation” are disabled (OFF).

In the case of the settings, display data is generated in the information processing device (server) 50 without performing display control such that the user utterance described with reference to FIGS. 22 and 24 is the center of conversation or display control according to the excitement of conversation as described with reference to FIG. 33. The user can view the display data generated thus.

Moreover, the information processing device (server) 50 performs processing for generating various types of display data for the users according to the settings of the users and providing the display data to the users.

Furthermore, when remote meetings are simultaneously held by various meeting groups under different themes, the users 11 can confirm the themes of the meetings by using the user terminals 21.

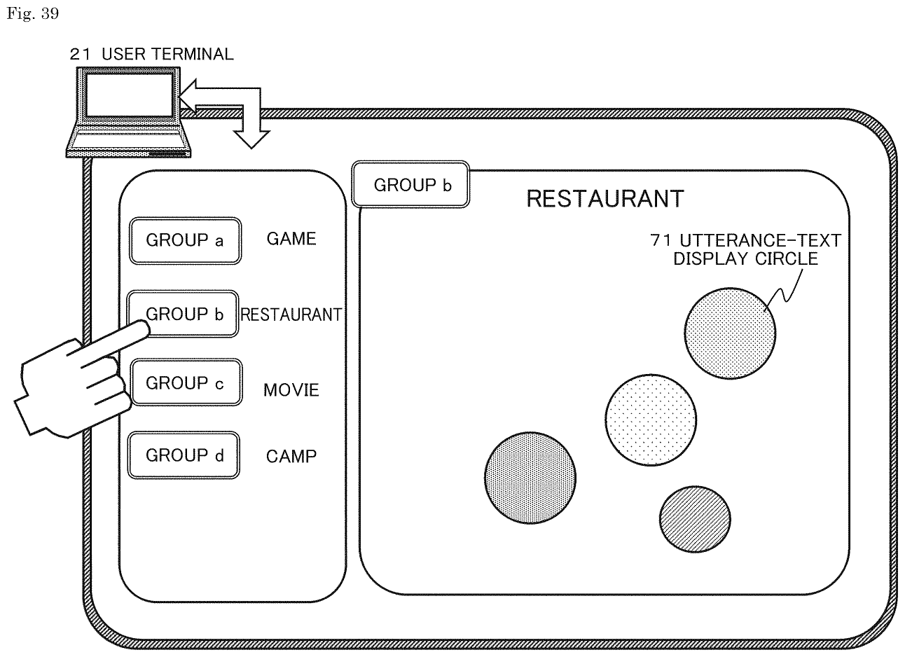

FIG. 39 shows an example of a UI (user interface) used for confirming the themes of meetings.

The UI (user interface) in FIG. 39 is also a UI displayed on the user terminal 21 used by the user 11.

At present, theme information about conversations among multiple groups in a remote meeting is displayed on the left side of the UI screen. These themes are estimated by conversation analysis processing in the information processing device (server) 50, for example, selection processing of main utterances or selection processing of keywords.

When the user selects one of these groups, the time series data of the utterance-text display circle corresponding to the group is displayed on the right side.

In the case of a touch panel, for example, one group icon (group b) is tapped with a finger as illustrated in the drawing. Alternatively, in the case of a PC or the like, group selection processing such as mouse-on or mouse-over processing for moving a cursor onto one group icon (group b) is performed. The group selection processing displays the time series data of the utterance-text display circle corresponding to the selected group is displayed on the right side.

In the illustrated example, the time series data of utterance-text display circles is displayed for the meeting of the group b under the theme of restaurants.

As described above, the user 11 can confirm the themes of meetings held by various groups and the time series data of user utterances in the groups through the user terminal 21 used by the user 11.

Furthermore, the time series data of user utterances on the right are display data visualizing the foregoing various visualized elements. The user can easily confirm, for example, whether conversations have warmed up by viewing the display data.

When multiple groups hold meetings under different themes, the user 11 can observe the time series data of user utterances for one group and further confirm the time series data of user utterances for multiple groups by using the user terminal 21.

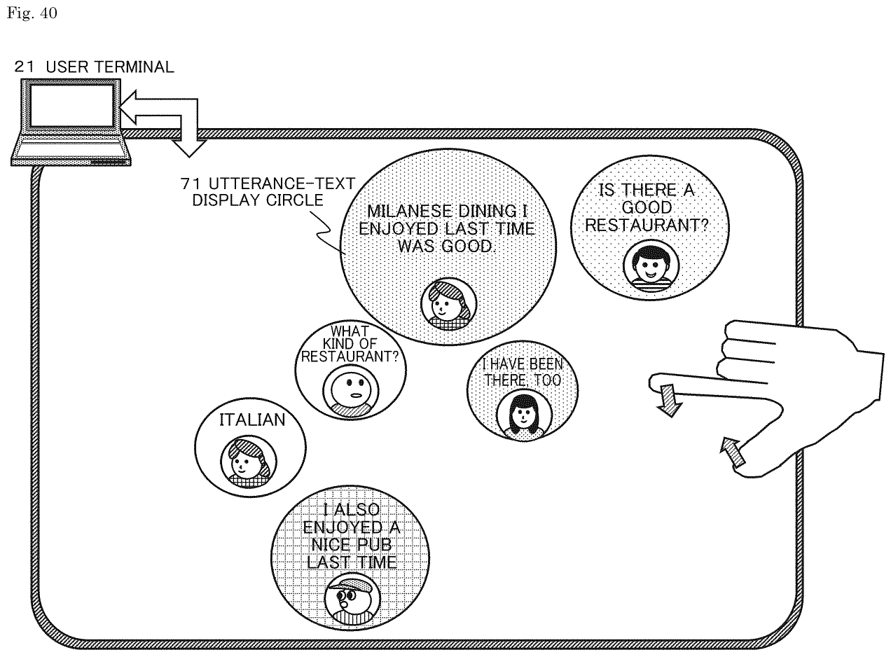

FIG. 40 shows display data indicating the time series data of user utterances for one group as described with reference to FIG. 2 and other drawings.

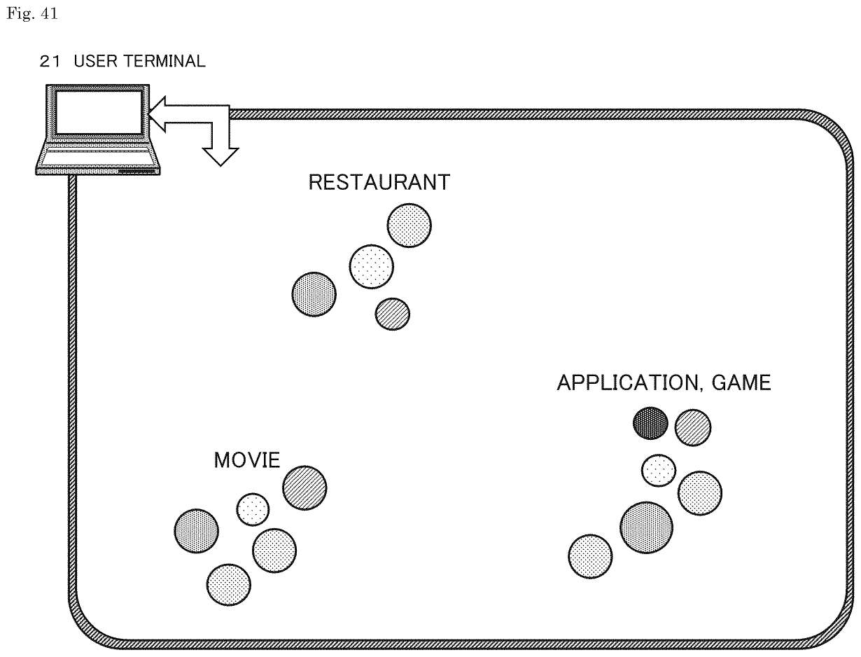

When the user 11 performs an operation for zooming out on the display part of the display data, for example, a keyboard operation of a PC or a pinch-in operation of closing two fingers on a touch panel, as shown in FIG. 41, thumbnails are displayed for the time series data of user utterances of multiple meeting groups on the display part.

However, utterance text to be displayed is less visible in the small thumbnails of the time series data of user utterances, and thus only the meeting themes of the groups are displayed.

Such display data allows the user to confirm the meeting themes of multiple meeting groups participating at the same time.

As a display variation other than the display of meeting themes alone, only keywords in utterance text may be left to be displayed. For example, in the case of utterance text “Milanese dining I enjoyed last time was good.”, only a keyword “Milanese dining” is displayed in the thumbnails of the time series data of user utterances. Moreover, when utterance text is short enough to eliminate the need for leaving only a keyword, the utterance text may be displayed as it is in the thumbnails of the time series data of user utterances. For example, for utterance text “What kind of restaurant?”, the text is sufficiently short and thus “What kind of restaurant?” may be displayed as it is. Furthermore, in the thumbnails of the time series data of user utterances, the user icons may be continuously displayed in the display circles.

Moreover, when the user 11 performs processing for selecting one group from the display data of thumbnails for the time series data of user utterances of multiple groups in FIG. 41, for example, a pinch-out operation of opening two fingers on a touch panel, the display data is displayed while enlarging the time series data of user utterances of the group, allowing confirmation of specific utterance text of each user.

### 5. Embodiment of Display Control Performed Using User Biological Information or the Like

An embodiment of display control performed using user biological information or the like will be described below.

In the foregoing embodiment, as described with reference to, for example, FIGS. 4 and 5, a voice acquired by the microphone of the user terminal 21 and an image captured by the camera are input to the information processing device (server) 50 from the user terminal 21, and the state of a user participating in a remote meeting and the state of the meeting are analyzed to generate display data according to the analysis result.

In the following embodiment, as input information from the user terminal 21, the information processing device (server) 50 receives biological information about the user 11 as well as a voice acquired by the microphone and an image captured by the camera, performs analysis processing on the input information, and more specifically estimates the user state to perform control processing on the display data.

The biological information about the user 11 input from the user terminal 21 is various types of biological information including, for example, the line of sight, pulse, heartbeat, temperature, and blood pressure of the user. The biological information is acquired by a sensor worn by the user 11 or sensors attached around the user 11 and is transmitted to the information processing device (server) 50 via the user terminal 21.

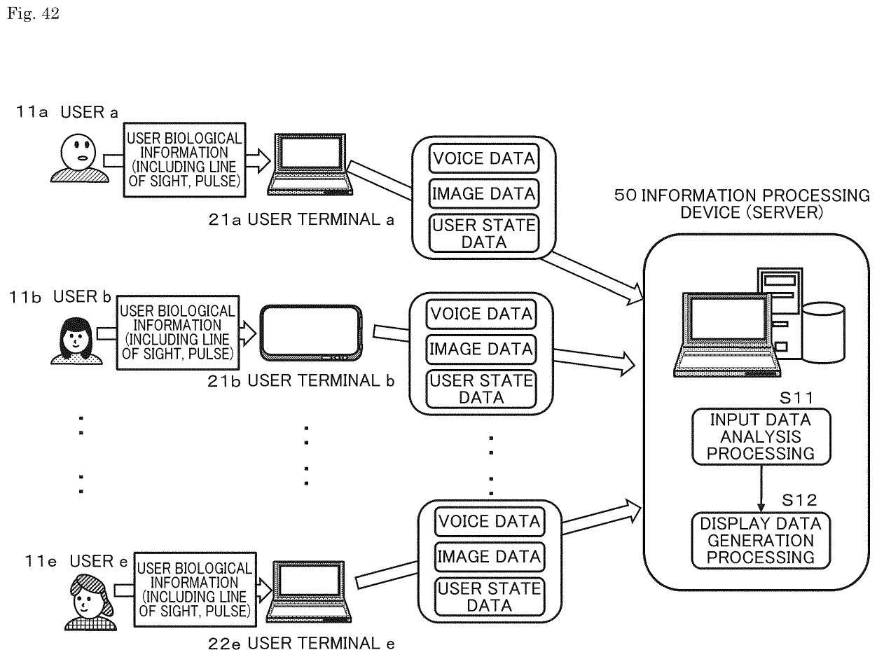

FIG. 42 is an explanatory drawing of a data flow between the user terminals 21 and the information processing device (server) 50 in the present embodiment.

FIG. 42 illustrates the user terminals 21a to 21e used by multiple users 11a to 11e in a remote meeting and the information processing device (server) 50 as in FIG. 4 described in the foregoing embodiment.

As illustrated in FIG. 42, the information processing device (server) 50 receives voice data and image data from the user terminals 21a to 21e used by the users 11a to 11e in a remote meeting, and further receives user biological information.

As described above, the biological information is, for example, various types of biological information including the line of sight, pulse, heartbeat, temperature, and blood pressure of the user. The biological information is acquired by a sensor worn by the user 11 or sensors attached around the user 11 and is transmitted to the information processing device (server) 50 via the user terminal 21.

As shown in FIG. 42, the information processing device (server) 50 performs the processing of steps S11 and S12.

Specifically, in step S11, analysis processing is performed on input data (voice data, image data, user biological information) received from the user terminals 21a to 21e.

In step S12, display data is generated using the data analysis result of step S11.

Specifically, display data including the time series data of the utterance-text display circles 71 is generated as illustrated in, for example, FIGS. 2 and 3 described in the foregoing embodiment.

The display data generated by the information processing device (server) 50 includes the time series data of the utterance-text display circles 71 in which the utterance contents of users participating in a remote meeting are displayed in text format. In the display data, the states of speaking users and the state of the meeting (the level of excitement) are visually understandable by, for example, the sizes, colors, and movements of the utterance-text display circles.

The information processing device (server) 50 can analyze the degree of concentration or the degree of interest of the user 11 in the meeting by analyzing, for example, the line of sight of the user, so that display data can be generated and displayed with the visualized degree of concentration or interest.

Furthermore, the information processing device (server) 50 can analyze the degree of calmness or the degree of excitement of the user by analyzing, for example, the temperature, pulse, and blood pressure of the user, so that display data can be generated and displayed with the visualized states of the user.

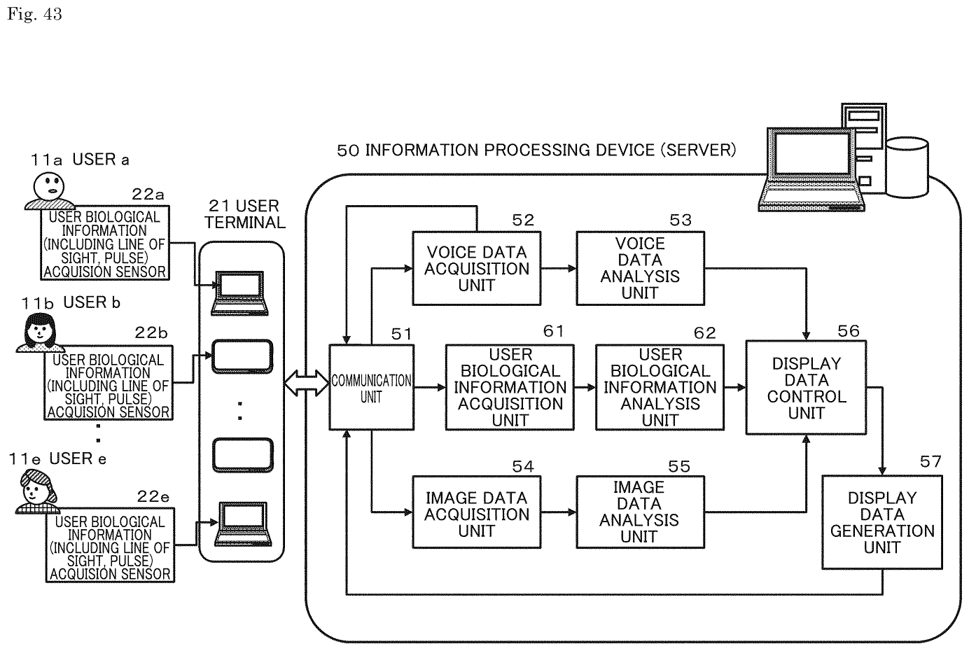

Referring to FIG. 43, a configuration example of the information processing device (server) 50 according to the present embodiment will be described below.

As shown in FIG. 43, the information processing device (server) 50 includes the communication unit 51, the voice data acquisition unit 52, the voice data analysis unit 53, the image data acquisition unit 54, the image data analysis unit 55, the display data control unit 56, the display data generation unit 57, a user biological information acquisition unit 61, and a user biological information analysis unit 62.

In this configuration, the communication unit 51, the voice data acquisition unit 52, the voice data analysis unit 53, the image data acquisition unit 54, the image data analysis unit 55, the display data control unit 56, and the display data generation unit 57 are the same components as those described with reference to FIG. 5 in the foregoing embodiment.

The communication unit 51 receives voice data, image data, and user biological information from the user terminals 21 in a remote meeting.

The voice data to be received is voice data that is acquired by the microphones of the user terminals 21 and includes the utterance voices of the users, laughter, clapping sound, and ambient sound.

Furthermore, the image data is image data that is acquired by the cameras of the user terminals 21 and includes the face images of the users.

As described above, the biological information is, for example, various types of biological information including the line of sight, pulse, heartbeat, temperature, and blood pressure of the user.

In addition, the communication unit 51 transmits voice data including user utterances acquired by the voice data acquisition unit 52 and display data generated by the display data generation unit 57, to the user terminals 21 in a remote meeting.

The user terminals 21 output voices such as user utterances, which are received from the information processing device (server) 50, through the speakers of the user terminals 21 or the headphones attached to the user terminals, and display image data, which is received from the information processing device (server) 50, on the display parts of the user terminals 21.

The processing performed by the voice data acquisition unit 52 and the voice data analysis unit 53 is the same as the processing described with reference to FIG. 5. Specifically, voice data acquired by the microphones of the user terminals 21, for example, voice data including user utterance voice, laughter, clapping sound, and ambient sound is analyzed, and the analysis result is input to the display data control unit 56.

The processing performed by the image data acquisition unit 54 and the image data analysis unit 55 is the same as the processing described with reference to FIG. 5. In other words, image data including the face images of users participating in a meeting, that is, image data acquired by the cameras of the user terminals 21 and is analyzed,
analysis processing is performed on facial expressions, a smiling face or positive actions such as a nod, an embarrassed or sad face, and negative actions such as headshaking, and the analysis result is input to the display data control unit 56.

The user biological information acquisition unit 61 selectively acquires user biological information from input data via the communication unit 51 and transfers the acquired user biological information to the user biological information analysis unit 62.

As described above, the biological information acquired by the user biological information acquisition unit 61 is, for example, various types of biological information including the line of sight, pulse, heartbeat, temperature, and blood pressure of the user. The biological information is data that is acquired by a sensor worn by the user 11 or sensors attached around the user 11 and is transmitted from the user terminal 21.

The user biological information analysis unit 62 analyzes the user biological information received from the user terminals 21.

For example, the received line of sight of the user from the user terminal 21 is analyzed to analyze the degree of concentration or the degree of interest of the user 11 in a meeting.

Furthermore, the degree of calmness or the degree of excitement of the user 11 is analyzed by analyzing the temperature, pulse, and blood pressure of the user.

These analysis results are input to the display data control unit 56.

The display data control unit 56 receives the voice data analysis result obtained by the voice data analysis unit 53, the image data analysis result obtained by the image data analysis unit 55, and the user biological information analysis result analyzed by the user biological information analysis unit 62 and performs, on the basis of the input data, control processing on image data to be provided to the user terminals 21, that is, the time-series display data of utterance-text display circles including the utterance text of a remote meeting as described with reference to FIGS. 2 and 3.

In the present embodiment, the display data control unit 56 can perform display data control processing in which a user state analyzed by the user biological information analysis unit 62 is reflected.

Specifically, display data is generated with the visualized degree of concentration or interest of the user in a meeting. The degree of concentration or interest is estimated on the basis of the analysis result of the line of sight of the user.

Furthermore, display data is generated with the degree of calmness or the degree of excitement of the user. The degree of calmness or excitement is estimated from the temperature, pulse, and blood pressure or the like of the user.

The display data control unit 56 performs various types of display data control processing including display data control processing for generating display data that visualizes the emotions and states of users participating in a remote meeting and an atmosphere such as the level of excitement of the overall meeting, that is, processing for determining the sizes, colors, movements, and other effect display modes or the like of utterance-text display circles constituting display data, and processing for determining a background color.

The control information of the display data control unit 56 is input to the display data generation unit 57.

The display data generation unit 57 generates display data according to the sizes, colors, and movements of utterance-text display circles determined by the display data control unit 56 and the mode of a background image.

The display data generated by the display data generation unit 57 is, for example, display data shown in FIGS. 2 and 3. The display data is provided to the user terminals 21 and is displayed on the display parts of the user terminals 21.

The users 11 can confirm the utterances of meeting participants as text information and grasp the states of the users and the state of conversation (the state of the meeting) by viewing the display data displayed on the display parts of the user terminals 21.

### 6. Configuration Example of User Terminal

A configuration of the user terminal will be described below.

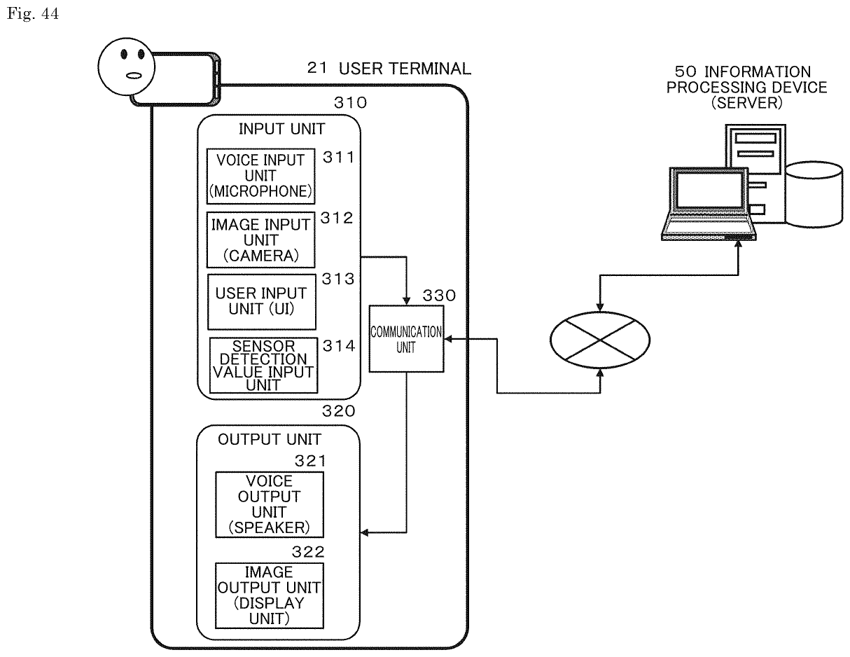

Referring to FIG. 44, a configuration example of the user terminal 21 used by the user 11 will be described below.

As shown in FIG. 44, the user terminal 21 includes an input unit 310, an output unit 320, and a communication unit 330.

The input unit 310 includes a voice input unit (microphone) 311, an image input unit (camera) 312, a user input unit (UI) 313, and a sensor detection value input unit 314.

The output unit 320 includes a voice output unit (speaker) 321 and an image output unit (display unit) 322.

The voice input unit (microphone) 311 of the input unit 310 acquires voice data including a user voice. The acquired voice data is transmitted to the information processing device (server) 50 via the communication unit 330.

The image input unit (camera) 312 acquires image data including the face images of users. The acquired image data is transmitted to the information processing device (server) 50 via the communication unit 330.

The user input unit (UI) 313 is, for example, a keyboard, a mouse, or a touch panel and is used for processing such as display data setting using a UI as described with reference to FIGS. 38 to 41.

The sensor detection value input unit 314 receives detection values from sensors that acquire user states such as biological information, for example, a line-of-sight detection sensor or sensors for measuring a pulse, a heartbeat, a temperature, and a blood pressure or the like. The input data is transmitted to the information processing device (server) 50 through the communication unit 330.

### 7. Hardware Configuration Example of Information Processing Device and User Terminal

A hardware configuration example of the information processing device (server) and the user terminal will be described below.

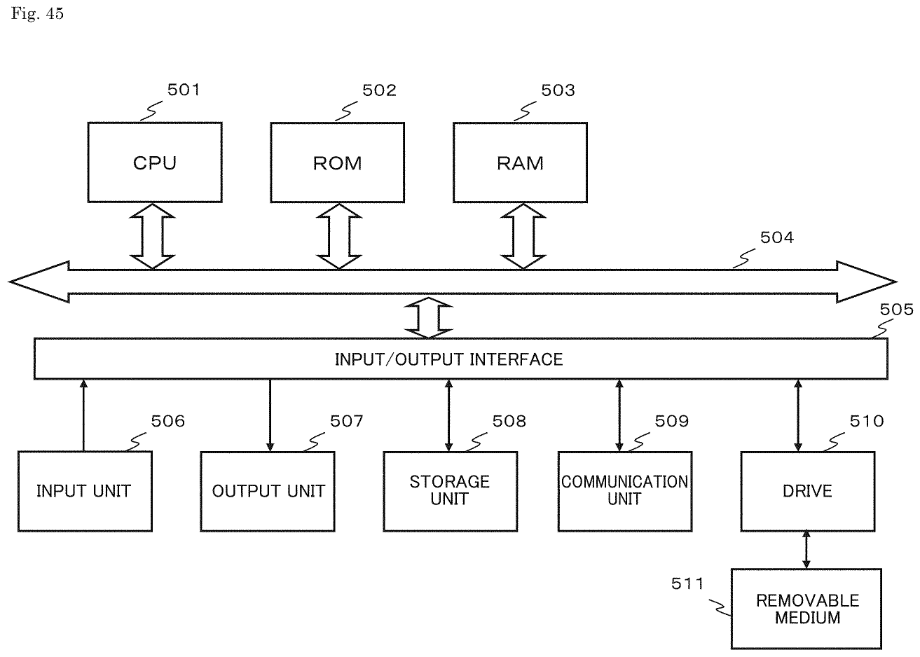

FIG. 45 shows an example of the hardware configuration of the information processing device (server) 50 and the user terminal 21 according to the present disclosure.

The hardware configuration illustrated in FIG. 45 will be described below.

A CPU (Central Processing Unit) 501 functions as a control unit and a data processing unit that execute various kinds of processing according to programs stored in a ROM (Read Only Memory) 502 or a storage unit 508. For example, the processing according to the sequence described in the foregoing embodiment is executed. A RAM (Random Access Memory) 503 stores programs and data executed by the CPU 501. The CPU 501, the ROM 502, and the RAM 503 are connected to one another via a bus 504.

The CPU 501 is connected to an input/output interface 505 via the bus 504, and the input/output interface 505 is connected to an input unit 506 including various switches, a keyboard, a mouse, a microphone, and a sensor, and an output unit 507 including a display and a speaker. The CPU 501 executes various processes in response to a command input from the input unit 506, and outputs the processing results to, for example, the output unit 507.

A storage unit 508 connected to the input/output interface 505 includes, for example, a hard disk and stores programs executed by the CPU 501 and various pieces of data. A communication unit 509 functions as a transmitting/receiving unit for Wi-Fi communication, Bluetooth (registered trademark) (BT) communication, and other data communication via networks such as the Internet and local area networks, and communicates with external devices.

A drive 510 connected to the input/output interface 505 drives a removable medium 511 such as a magnetic disk, an optical disc, a magneto-optical disc, or a semiconductor memory such as a memory card, and records or reads data.

### 8. Summary of Configuration of Present Disclosure

Embodiments of the present disclosure have been described above in detail with reference to a specific embodiment. However, it will be apparent to those skilled in the art that modification and substation of the embodiments can be made without departing from the gist of the technology disclosed in the present disclosure. That is, the present invention has been disclosed according to an illustrative form, but the present disclosure should not be restrictively construed. The gist of the present disclosure should be determined in consideration of the claims.

The technique disclosed in the present specification can be configured as follows:
(1) An information processing device including:
   a data analysis unit that analyzes received data from a user terminal carrying out a conversation via a communication network; and
   a display data control unit that controls display data having an utterance-text display region including text corresponding to a user utterance to be provided to the user terminal, on the basis of the analysis result of the data analysis unit, wherein
   the display data control unit controls the display mode of at least one of the utterance-text display region and a background region and generates display data visualizing at least one of a user state and a conversation state of a user carrying out a conversation.
(2) The information processing device according to (1), wherein
   the display data control unit controls the size, position, color, or a movement of the utterance-text display region or at least one of output images around the utterance-text display region, and generates display data visualizing at least one of a user state and a conversation state of the user carrying out a conversation.
(3) The information processing device according to (1) or (2), wherein
   the data analysis unit analyzes voice data and image data that are received from the user terminal, and
   the display data control unit controls display data displayed on the user terminal, on the basis of at least one of the analysis result of voice data and the analysis result of image data analyzed by the data analysis unit.
(4) The information processing device according to any one of (1) to (3), wherein the display data control unit changes the size of the utterance-text display region according to the volume of a user utterance analyzed by the data analysis unit.
(5) The information processing device according to any one of (1) to (4), wherein the display data control unit changes the color of the utterance-text display region or outputs an effect image around the utterance-text display region according to the tone of a user utterance analyzed by the data analysis unit.
(6) The information processing device according to any one of (1) to (5), wherein the display data control unit performs at least one of processing for zooming in on a keyword region in text corresponding to a user utterance to be displayed in the utterance-text display region and processing for displaying a changed color, according to a keyword in a user utterance analyzed by the data analysis unit.
(7) The information processing device according to any one of (1) to (6), wherein the display data control unit changes the display position of the utterance-text display region or changes the color of the utterance-text display region according to time-series information of a user utterance analyzed by the data analysis unit.
(8) The information processing device according to any one of (1) to (7), wherein the display data control unit performs at least one of processing for controlling the display position or the size of the utterance-text display region corresponding to a main user utterance or a dominant user utterance that is selected from a plurality of user utterances by the data analysis unit, and processing for additionally displaying a conversation center identification icon.
(9) The information processing device according to any one of (1) to (8), wherein when an analysis result that a subsequent user utterance corresponds to a specific preceding utterance is input as the analysis result of the data analysis unit,
   the display data control unit displays the utterance-text display region of the subsequent utterance while moving the utterance-text display region into contact with or close to an utterance-text display region corresponding to the preceding utterance.
(10) The information processing device according to any one of (1) to (9), wherein when an analysis result that a subsequent user utterance is a positive utterance corresponding to a specific preceding utterance is input as the analysis result of the data analysis unit,
   the display data control unit performs at least one of display control for displaying the utterance-text display region of the subsequent utterance while moving the utterance-text display region close to an utterance-text display region corresponding to the preceding utterance and
   display control processing for setting the color of the utterance-text display region of the subsequent utterance to a color similar to the color of an utterance-text display region corresponding to the preceding utterance.
(11) The information processing device according to any one of (1) to (10), wherein when an analysis result that a subsequent user utterance is a negative utterance corresponding to a specific preceding utterance is input as the analysis result of the data analysis unit,
   the display data control unit performs at least one of display control for displaying the utterance-text display region of the subsequent utterance while moving the utterance-text display region to be separated from an utterance-text display region corresponding to the preceding utterance and
   display control processing for setting the color of the utterance-text display region of the subsequent utterance to a color different from the color of an utterance-text display region corresponding to the preceding utterance.
(12) The information processing device according to any one of (1) to (11), wherein when the data analysis unit detects a positive action of the user,
   the display data control unit performs at least one of control for shaking the utterance-text display circle or the user icon of a user making a positive action, control for upsizing and downsizing, and color changing control for changing a color to a bright color, and
   when the data analysis unit detects a negative action of the user,
   the display data control unit performs at least one of control for shaking the utterance-text display circle or the user icon of a user making a negative action, control for upsizing and downsizing, and color changing control for changing a color to a dark color.
(13) The information processing device according to any one of (1) to (12), wherein when the data analysis unit detects excitement of a conversation,
   the display data control unit performs at least one of control for shaking the utterance-text display circle or the user icon of a user, control for upsizing and downsizing, color changing control for changing a color to a bright color, and background color changing control for changing, to a bright color, the color of a background region including an utterance-text display region corresponding to a plurality of user utterances constituting the conversation indicating excitement.
(14) The information processing device according to any one of (1) to (13), wherein when the data analysis unit detects decreasing excitement of a conversation,
   the display data control unit performs at least one of control for shaking the utterance-text display circle or the user icon of a user, control for upsizing and downsizing, color changing control for changing a color to a dark color, and background color changing control for changing, to a dark color, the color of a background region including an utterance-text display region corresponding to a plurality of user utterances constituting the conversation indicating decreasing excitement.
(15) The information processing device according to any one of (1) to (14), wherein when receiving the analysis result of opinions corresponding to a plurality of user utterances from the data analysis unit,
   the display data control unit performs at least one of display control for generating and displaying a data series of individual utterance-text display regions for each of opinion groups and display control for setting and displaying the colors of utterance-text display regions of the same opinion or similar opinions in a similar color.
(16) The information processing device according to any one of (1) to (15), wherein the received data from the user terminal includes user biological information,
   the data analysis unit analyzes the user biological information received from the user terminal, and
   the display data control unit controls display data displayed on the user terminal, on the basis of the analysis result of the user biological information analyzed by the data analysis unit.
(17) The information processing device according to any one of (1) to (16), wherein the display data control unit generates display data according to user setting information input from the user terminal.
(18) The information processing device according to (17), wherein
   the user setting information includes at least one of on/off setting information of individual visualized elements and visualization level setting information of individual visualized elements.
(19) An information processing system including: a plurality of user terminals that carry out a conversation via a communication network, and a server that manages the conversation, wherein
   the user terminal transmits voice data acquired through a microphone and image data captured by a camera to the server,
   the server analyzes the voice data and the image data that are received from the user terminal,
   as control processing of display data having an utterance-text display region including text corresponding to a user utterance to be provided to the user terminal, the control processing being based on the analysis result,
   the server adjusts the display mode of at least one of the utterance-text display region and a background region and generates display data visualizing at least one of a user state and a conversation state of a user carrying out a conversation, and
   the user terminal displays the display data including the utterance-text display region on a display part, the display data being generated by the server.
(20) An information processing method performed in an information processing device, the method including:
   a data analysis step of analyzing received data from a user terminal carrying out a conversation via a communication network by a data analysis unit; and
   a display data control step of controlling display data having an utterance-text display region including text corresponding to a user utterance to be provided to the user terminal, on the basis of the analysis result of the data analysis step, by a display data control unit, wherein
   the display data control step is a step of controlling the display mode of at least one of the utterance-text display region and a background region and generating display data visualizing at least one of a user state and a conversation state of a user carrying out a conversation.

Furthermore, the series of processing described in this description can be executed by hardware, software, or a composite configuration of both. If the series of processing is to be executed by software, the series of processing can be executed by installing a program recording the processing sequence into a memory in a computer embedded in dedicated hardware, or by installing the program into a general-purpose computer capable of executing various kinds of processing. For example, the program can be pre-recorded on a recording medium. Rather than being installed into a computer from a recording medium, the program can be received via a network such as a LAN (Local Area Network) or the Internet, and installed into a built-in recording medium such as a hard disk.

The various processes described in this specification can be performed consecutively in the described order or may be performed in parallel or individually depending on the processing capability of the device performing the processes or as needed. In the present specification, the system is a logical set of configurations of a plurality of devices, and the devices having each configuration are not limited to those in the same housing.

### INDUSTRIAL APPLICABILITY

As described above, according to the configuration of an embodiment of the present disclosure, a configuration is implemented to control display data displayed on the display part of a user terminal that carries out a conversation via a communication network and generate display data visualizing a user state and a conversation state.

Specifically, for example, the configuration analyzes received data from the user terminal carrying out a conversation via the communication network, and controls display data having an utterance-text display region including text corresponding to a user utterance to be provided to the user terminal, on the basis of the analysis result. The display data control unit controls the size, position, color, or a movement of the utterance-text display region or at least one of output images around the utterance-text display region, and generates display data visualizing at least one of a user state and a conversation state of the user carrying out a conversation.

With this configuration, a configuration is implemented to control display data displayed on the display part of the user terminal that carries out a conversation via the communication network and generate display data visualizing a user state and a conversation state.

### REFERENCE SIGNS LIST

11 User
21 User terminal
50 Information processing device (server)
51 Communication unit
52 Voice data acquisition unit
53 Voice data analysis unit
54 Image data acquisition unit
55 Image data analysis unit
56 Display data control unit
57 Display data generation unit
61 User biological information acquisition unit
62 User biological information analysis unit
71 Utterance-text display circle
72 Utterance text
73 User icon
310 Input unit
311 Voice input unit (microphone)
312 Image input unit (camera)
313 User input unit (UI)
314 Sensor detection value input unit
320 Output unit
321 Voice output unit (speaker)
322 Image output unit (display unit)
330 Communication unit
501 CPU
502 ROM
503 RAM
504 Bus
505 Input/output interface
506 Input unit
507 Output unit
508 Storage unit
509 Communication unit
510 Drive
511 Removable medium

1. An information processing device comprising:
a data analysis unit that analyzes received data from a user terminal carrying out a conversation via a communication network; and
a display data control unit that controls display data having an utterance-text display region including text corresponding to a user utterance to be provided to the user terminal, on a basis of an analysis result of the data analysis unit, wherein
the display data control unit controls a display mode of at least one of the utterance-text display region and a background region and generates display data visualizing at least one of a user state and a conversation state of a user carrying out a conversation.

2. The information processing device according to claim 1, wherein
the display data control unit controls a size, position, color, or a movement of the utterance-text display region or at least one of output images around the utterance-text display region, and generates display data visualizing at least one of a user state and a conversation state of the user carrying out a conversation.

3. The information processing device according to claim 1, wherein
the data analysis unit analyzes voice data and image data that are received from the user terminal, and
the display data control unit controls display data displayed on the user terminal, on a basis of at least one of an analysis result of voice data and an analysis result of image data analyzed by the data analysis unit.

4. The information processing device according to claim 1, wherein
the display data control unit changes a size of the utterance-text display region according to a volume of a user utterance analyzed by the data analysis unit.

5. The information processing device according to claim 1, wherein
the display data control unit changes a color of the utterance-text display region or outputs an effect image around the utterance-text display region according to a tone of a user utterance analyzed by the data analysis unit.

6. The information processing device according to claim 1, wherein
the display data control unit performs at least one of processing for zooming in on a keyword region in text corresponding to a user utterance to be displayed in the utterance-text display region and processing for displaying a changed color, according to a keyword in a user utterance analyzed by the data analysis unit.

7. The information processing device according to claim 1, wherein
the display data control unit changes a display position of the utterance-text display region or changes a color of the utterance-text display region according to time-series information of a user utterance analyzed by the data analysis unit.

8. The information processing device according to claim 1, wherein
the display data control unit performs at least one of processing for controlling a display position or a size of the utterance-text display region corresponding to a main user utterance or a dominant user utterance that is selected from a plurality of user utterances by the data analysis unit, and processing for additionally displaying a conversation center identification icon.

9. The information processing device according to claim 1, wherein
when an analysis result that a subsequent user utterance corresponds to a specific preceding utterance is input as the analysis result of the data analysis unit,
the display data control unit displays the utterance-text display region of the subsequent utterance while moving the utterance-text display region into contact with or close to an utterance-text display region corresponding to the preceding utterance.

10. The information processing device according to claim 1, wherein
when an analysis result that a subsequent user utterance is a positive utterance corresponding to a specific preceding utterance is input as the analysis result of the data analysis unit,
the display data control unit performs at least one of display control for displaying the utterance-text display region of the subsequent utterance while moving the utterance-text display region close to an utterance-text display region corresponding to the preceding utterance and
display control processing for setting a color of the utterance-text display region of the subsequent utterance to a color similar to a color of the utterance-text display region corresponding to the preceding utterance.

11. The information processing device according to claim 1, wherein
when an analysis result that a subsequent user utterance is a negative utterance corresponding to a specific preceding utterance is input as the analysis result of the data analysis unit,
the display data control unit performs at least one of display control for displaying the utterance-text display region of the subsequent utterance while moving the utterance-text display region to be separated from an utterance-text display region corresponding to the preceding utterance and
display control processing for setting a color of the utterance-text display region of the subsequent utterance to a color different from a color of an utterance-text display region corresponding to the preceding utterance.

12. The information processing device according to claim 1, wherein
when the data analysis unit detects a positive action of the user,
the display data control unit performs at least one of control for shaking the utterance-text display circle or a user icon of a user making a positive action, control for upsizing and downsizing, and color changing control for changing a color to a bright color, and
when the data analysis unit detects a negative action of the user,
the display data control unit performs at least one of control for shaking the utterance-text display circle or the user icon of a user making a negative action, control for upsizing and downsizing, and color changing control for changing a color to a dark color.

13. The information processing device according to claim 1, wherein
when the data analysis unit detects excitement of a conversation,
the display data control unit performs at least one of control for shaking the utterance-text display circle or a user icon of a user, control for upsizing and downsizing, color changing control for changing a color to a bright color, and background color changing control for changing, to a bright color, a color of a background region including an utterance-text display region corresponding to a plurality of user utterances constituting the conversation indicating excitement.

14. The information processing device according to claim 1, wherein
when the data analysis unit detects decreasing excitement of a conversation,
the display data control unit performs at least one of control for shaking the utterance-text display circle or a user icon of a user, control for upsizing and downsizing, color changing control for changing a color to a dark color, and background color changing control for changing, to a dark color, a color of a background region including an utterance-text display region corresponding to a plurality of user utterances constituting the conversation indicating decreasing excitement.

15. The information processing device according to claim 1, wherein
when receiving a classification result of opinions corresponding to a plurality of user utterances from the data analysis unit,
the display data control unit performs at least one of display control for generating and displaying a data series of individual utterance-text display regions for each of opinion groups and display control for setting and displaying colors of utterance-text display regions of the same opinion or similar opinions in a similar color.

16. The information processing device according to claim 1, wherein
the received data from the user terminal includes user biological information,
the data analysis unit analyzes the user biological information received from the user terminal, and
the display data control unit controls display data displayed on the user terminal, on a basis of an analysis result of the user biological information analyzed by the data analysis unit.

17. The information processing device according to claim 1, wherein
the data display control unit generates display data according to user setting information input from the user terminal.

18. The information processing device according to claim 17, wherein
the user setting information includes at least one of on/off setting information of individual visualized elements and visualization level setting information of individual visualized elements.

19. An information processing system comprising: a plurality of user terminals that carry out a conversation via a communication network, and a server that manages the conversation, wherein
the user terminal transmits voice data acquired through a microphone and image data captured by a camera to the server,
the server analyzes the voice data and the image data that are received from the user terminal,
as control processing of display data having an utterance-text display region including text corresponding to a user utterance to be provided to the user terminal, the control processing being based on an analysis result,
the server adjusts a display mode of at least one of the utterance-text display region and a background region and generates display data visualizing at least one of a user state and a conversation state of a user carrying out a conversation, and
the user terminal displays the display data including the utterance-text display region on a display part, the display data being generated by the server.

20. An information processing method performed in an information processing device, the method comprising:
a data analysis step of analyzing received data from a user terminal carrying out a conversation via a communication network by a data analysis unit; and
a display data control step of controlling display data having an utterance-text display region including text corresponding to a user utterance to be provided to the user terminal, on a basis of an analysis result of the data analysis step, by a display data control unit, wherein
the display data control step is a step of controlling a display mode of at least one of the utterance-text display region and a background region and generating display data visualizing at least one of a user state and a conversation state of a user carrying out a conversation.
